(19) United States
(12) Patent Application Publication
(10) Pub. No.: US 2026/0289082 A1
(43) Pub. Date: Sep. 24, 2026

(54) SYSTEM

(71) Applicant: SoftBank Group Corp., Tokyo (JP)

(72) Inventor: Hikaru TAKENAKA, Tokyo (JP)

(73) Assignee: SoftBank Group Corp., Tokyo (JP)

(21) Appl. No.: 19/565,546

(22) Filed: Mar. 13, 2026

(30) Foreign Application Priority Data
Mar. 19, 2025 (JP) 2025-045144

(51) Int. Cl. G06F 40/166; G06F 3/0482; G06F 40/253; G06F 40/289; G06F 40/35; G06F 40/40; H04L 51/02

(52) U.S. Cl. CPC G06F 40/166; G06F 3/0482; G06F 40/253; G06F 40/289; G06F 40/35; G06F 40/40; H04L 51/02

(57) ABSTRACT

A system includes a processor that is configured to collect a history of a communication application of a user and analyze a conversation style and an emotional state of the user by using a natural language processing technique, input a prompt to a generative AI model to instruct generation of reply candidates based on the analyzed conversation style and emotional state and generate reply candidates that mimic replies of the user, and present the generated reply candidates to the user and transmit, by using the communication application, a reply candidate selected by the user.

### CROSS-REFERENCE TO RELATED APPLICATION

This application is based on and claims priority under 35 USC 119 from Japanese Patent Application No. 2025-045144 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, various communication applications have become widely used, and users are required to respond to a large number of incoming messages in both private and business contexts. However, conventional automatic reply systems typically generate responses based only on generic language models or simple templates, and therefore fail to adequately reflect each user's individual conversation style, tone, or emotional state. As a result, automatically generated replies often feel unnatural or impersonal to recipients, and users are required to spend additional time editing or rewriting such replies. Moreover, conventional systems generally do not analyze a user's emotional tendency from conversation history, and thus cannot adapt reply generation in consideration of whether the user's typical expressions or current state are positive or negative. This lack of personalization and emotional awareness reduces user satisfaction and can impair communication efficiency. Accordingly, there is a need for a system capable of collecting and analyzing a user's communication application history, accurately modeling the user's conversation style and emotional tendency, and generating, via a generative AI model, reply candidates that appropriately mimic the user's own replies and support efficient and natural communication.

### SUMMARY

To solve the above-described problems, according to one aspect of the present invention, there is provided a system comprising a processor, wherein the processor is configured to collect a history of a communication application of a user and analyze, by using a natural language processing technique, a conversation style and an emotional state of the user. The processor is further configured to input a prompt to a generative AI model to instruct generation of reply candidates based on the analyzed conversation style and emotional state and to generate reply candidates that mimic replies of the user. In addition, the processor is configured to present the generated reply candidates to the user and to transmit, by using the communication application, a reply candidate selected by the user. In certain embodiments, the processor inputs the prompt to the generative AI model so as to cause the generative AI model itself to generate the reply candidates in accordance with the user's style. In further embodiments, the processor detects positive or negative expressions from the conversation history of the user by using the natural language processing technique and quantifies an emotional tendency of the user, and the quantified emotional tendency is reflected in the prompt or in the generation control of the generative AI model. Through these configurations, the system can automatically propose reply candidates that closely resemble the user's natural wording and emotional tone, thereby improving both communication efficiency and the naturalness of the user's responses.

The term “communication application” refers to a software application or service that enables a user to exchange messages, such as text, audio, images, or video, with one or more other users over a network, including but not limited to messenger applications, chat applications, email applications, and social networking applications having messaging functions.

The term “history of a communication application” refers to a collection of past communication records associated with a user in a communication application, including at least message contents and optionally metadata such as timestamps, sender and recipient identifiers, and conversation identifiers.

The term “conversation style” refers to a characteristic manner in which a user expresses messages in a conversation, including but not limited to preferred vocabulary, grammar, phrasing patterns, politeness level, tone, formality, and typical response patterns.

The term “emotional state” refers to an inferred emotional condition of a user at a particular time or over a period of time, such as positive, negative, neutral, or more specific emotions, as estimated from the user's expressions contained in the history of the communication application.

The term “natural language processing technique” refers to a computational method or algorithm that processes, analyzes, or interprets human language expressed in text form, including but not limited to tokenization, part-of-speech tagging, sentiment analysis, emotion detection, syntactic or semantic analysis, and text classification.

The term “generative AI model” refers to a machine learning model configured to generate new text data, such as reply sentences, based on input data or prompts, and may include, for example, a neural network-based language model, a transformer model, or any other text generation model.

The term “prompt” refers to an input text or structured input data supplied to the generative AI model for controlling or conditioning the generation of output text, the prompt including at least information derived from the conversation style and the emotional state of the user.

The term “reply candidates” refers to one or more proposed reply messages generated by the generative AI model or under its control, which are suitable for being sent as a response in a communication application and are configured to mimic replies that the user would naturally produce.

The term “mimic replies of the user” refers to generating reply candidates whose expressions resemble those of the user in terms of conversation style, such as choice of words, tone, politeness level, structure, and typical patterns observed in the user's past messages.

The term “emotional tendency” refers to a quantitative representation of a user's emotional inclination over a period of time, such as a score or set of scores indicating how frequently or strongly the user expresses positive or negative emotions in the conversation history.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

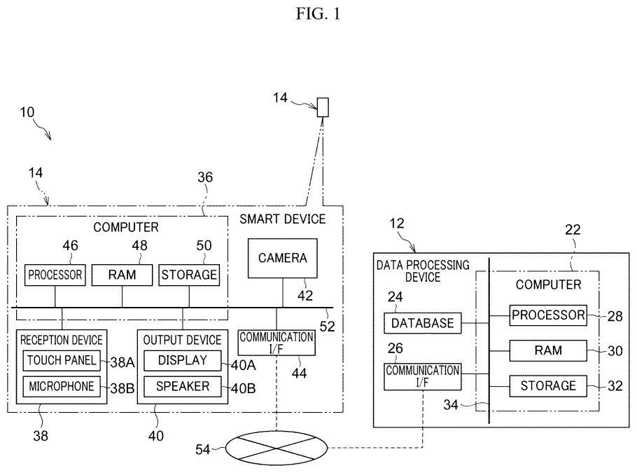

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

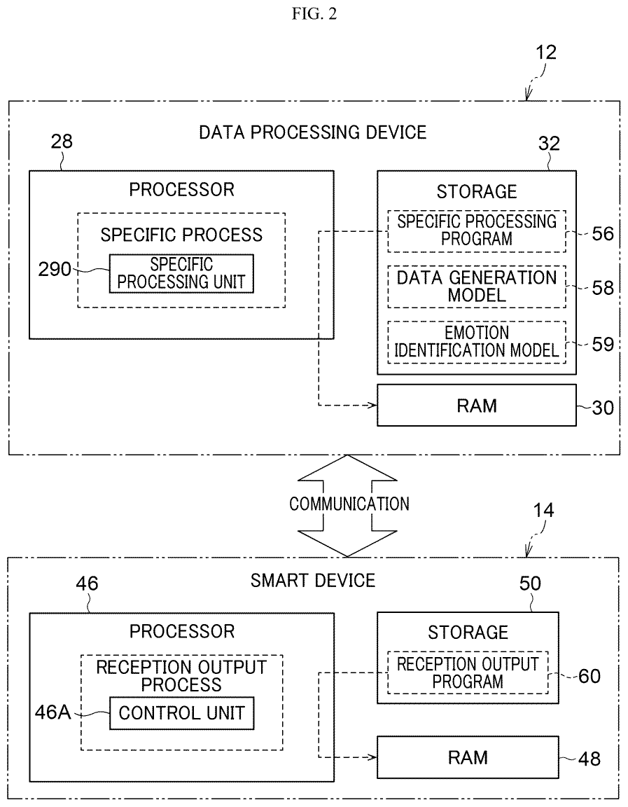

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional communication systems that utilize automated response generation, a computing device typically applies a general-purpose language model to conversation data and directly generates reply candidates. Such approaches suffer from multiple technical limitations at the level of computer processing itself. First, the conversation history is often handled as raw or minimally processed text, without systematic normalization, feature extraction, or structured user modeling. As a result, the system is unable to efficiently represent user-specific language usage tendencies, topic preferences, or emotional tendencies in a machine-usable form, which leads to suboptimal utilization of processor and memory resources and degrades the quality and consistency of generated responses.

Second, conventional systems generally do not construct a dedicated user style representation based on unsupervised learning over large-scale conversation history. Instead, they rely on generic parameters of a pre-trained generative model. This prevents the computing device from exploiting the statistical structure of user-specific data, and forces the generative model to perform additional implicit inference at generation time, increasing computational overhead and latency. It also leads to unstable response behavior across sessions, because user-specific context is not maintained as a stable representation in the system's data structures.

Third, in many existing techniques, the prompt sentence supplied to a generative AI model is formed without explicit conditioning on structured user style features, such as embedding vectors derived from learned feature data or explicit topic distributions. In such cases, the generative model must internally infer both the task and the style, which imposes redundant computations and may require larger models and more processing cycles. This is inefficient in terms of processor utilization and can lead to higher energy consumption and longer response times.

Fourth, emotion-related information and other high-level characteristics of conversation history are often either ignored or handled with ad hoc rules that are not integrated into the underlying feature representation. As a consequence, the system cannot systematically control the emotional tendency of generated responses based on structured emotion features. This limits the ability of the computer system to consistently produce emotionally appropriate outputs and to optimize generation behavior in a data-driven manner.

Accordingly, there is a need for a computer-implemented system and method that improves the way a processor acquires, preprocesses, and encodes conversation history into structured feature data, constructs a user style representation using unsupervised learning, and utilizes that representation to form style-aware prompt sentences and conditioning information for a generative AI model. By reorganizing the data processing pipeline and introducing explicit user style representations, the system can reduce redundant computations inside the generative model, improve processor and memory efficiency, and generate more consistent and user-aligned responses, thereby improving the functioning of the computer itself.

The specific processing by the specific processing unit 290 of the data processing device 12 in Example 1 is realized by the following means.

The present invention provides a server comprising a processor configured to acquire conversation history data from a communication application associated with a user via authentication information, to perform preprocessing on message content in the conversation history data including character type conversion, removal of unnecessary symbols, word segmentation, and removal of function words so as to generate standardized text data suitable for analysis, to generate feature data including word frequency information, phrase sequence frequency information, topic distribution information, writing style information, and optionally emotion feature information by applying statistical natural language processing and machine learning to the standardized text data, to construct a learning model using an unsupervised learning algorithm based on the feature data and to generate a user style representation representing a language usage tendency and a conversation topic tendency of the user, to generate a style-aware prompt sentence to be input to a generative AI model based on the user style representation and a prompt sentence received from the user, to cause the generative AI model to receive, as conditioning information, an embedding vector or topic information corresponding to the user style representation and to automatically generate response candidates in combination with the style-aware prompt sentence, and to select, from among response candidates output from the generative AI model, a response candidate consistent with the user style representation, present the selected response candidate to the user, and transmit a response candidate selected by the user via the communication application. This enables the server to reorganize conversation history into optimized standardized text and feature representations, to offload inference of user style from the generative model into an explicit user style representation learned by unsupervised algorithms, to reduce redundant internal computation within the generative AI model by supplying structured conditioning information and style-aware prompt sentences, to improve utilization of processor and memory resources during response generation, and to generate more stable, user-aligned responses that reflect user-specific language and emotional tendencies, thereby improving the overall functioning and efficiency of the computer-implemented communication system.

The term “communication application” refers to a software application or service that enables a user to send and receive electronic messages, including text messages, multimedia messages, or similar communication content, over a network.

The term “conversation history data” refers to data representing past communications conducted via a communication application, including message content, sender and recipient identifiers, timestamps, and associated metadata.

The term “authentication information” refers to information used to verify authorization of access to a communication application or associated data, including credentials such as tokens, keys, usernames, passwords, or authorization codes.

The term “message content” refers to textual information contained in a communication record of the conversation history data, excluding system-level control information or metadata.

The term “time information” refers to data indicating the time at which each message in the conversation history data was sent or received, including timestamps or time-related metadata.

The term “preprocessing” refers to a set of operations applied to raw message content to convert it into a normalized form suitable for analysis, including at least one of character type conversion, removal of unnecessary symbols, word segmentation, and removal of function words.

The term “character type conversion” refers to converting characters in the message content into a unified representation, such as converting uppercase to lowercase or converting full-width characters to half-width characters.

The term “removal of unnecessary symbols” refers to deleting symbols or characters in the message content that are not needed for language analysis, such as certain punctuation marks, decorative symbols, or control characters.

The term “word segmentation” refers to the process of dividing a sequence of characters into individual words or tokens according to linguistic rules or statistical criteria.

The term “function word” refers to a word that primarily serves a grammatical function rather than conveying substantial lexical meaning, such as articles, conjunctions, or certain pronouns, which may be removed during preprocessing.

The term “standardized text data” refers to text data obtained after preprocessing, in which message content has been normalized and formatted into a consistent structure suitable for subsequent analysis and feature extraction.

The term “statistical natural language processing” refers to techniques for analyzing text using statistical methods, including frequency analysis, probabilistic models, or vectorization methods applied to the standardized text data.

The term “machine learning” refers to computational methods that allow a model to learn patterns or structures from data and to improve its performance on a task based on such learned patterns without being explicitly programmed for each possible input.

The term “feature data” refers to data that numerically or categorically represents characteristics of the standardized text data, including at least one of word frequency information, phrase sequence frequency information, topic distribution information, writing style information, and emotion feature information.

The term “word frequency information” refers to data indicating how often particular words appear in the standardized text data, optionally normalized or weighted by statistical measures.

The term “phrase sequence frequency information” refers to data indicating how often particular sequences of words or n-grams appear in the standardized text data.

The term “topic distribution information” refers to data representing the degree to which different latent topics are associated with messages or documents in the standardized text data, typically expressed as probabilities or scores over multiple topics.

The term “writing style information” refers to data capturing stylistic characteristics of text, such as preferred expressions, sentence structure patterns, formality level, or other stylistic tendencies derived from the standardized text data.

The term “emotion feature information” refers to data representing emotional characteristics of message content, including indicators or scores for emotions such as positive, negative, neutral, or more fine-grained emotional states.

The term “learning model” refers to a computational model that is trained using machine learning techniques to represent patterns in the feature data.

The term “unsupervised learning algorithm” refers to a machine learning algorithm that learns structure or patterns from unlabeled data, without using explicit target labels, including clustering methods, dimensionality reduction methods, or autoencoding methods.

The term “user style representation” refers to data, including at least one vector or parameter set, that represents language usage tendencies, conversation topic tendencies, and optionally emotional tendencies of a user, learned from feature data by a learning model.

The term “prompt sentence” refers to text input provided by a user that requests or conditions generation of a response by a generative model.

The term “style-aware prompt sentence” refers to a prompt sentence that has been modified or augmented based on a user style representation so as to include or reflect style information associated with the user.

The term “generative AI model” refers to a machine learning model configured to generate new text sequences or other content based on input data, including but not limited to neural language models that produce response candidates from a prompt sentence.

The term “conditioning information” refers to auxiliary information provided to a generative AI model in addition to a prompt sentence, which influences the generation process, and may include user style representations, embedding vectors, or topic information.

The term “embedding vector” refers to a numerical vector representation of a user style, word, phrase, or other linguistic unit, obtained by applying a machine learning model to map such unit into a continuous vector space.

The term “topic information” refers to data that indicates one or more topics associated with a user or a set of messages, including topic identifiers, topic probabilities, or topic-related keywords.

The term “response candidate” refers to a text sequence generated by a generative AI model in response to a prompt sentence and any associated conditioning information, which is considered as a possible reply to be presented to the user.

The term “consistent with the user style representation” refers to a property of a response candidate indicating that the response candidate aligns with or matches the language usage tendencies, topic tendencies, or emotional tendencies encoded in the user style representation.

The term “present to the user” refers to causing information, including response candidates, to be displayed or otherwise output on a user interface of a device accessible to the user.

The term “transmit via the communication application” refers to sending selected response content through the communication application such that the response becomes part of the conversation handled by that application.

In one embodiment, a server, a terminal, and a user cooperate to implement the claimed system. The server includes at least one processor, a main memory, a non-volatile storage device, and a network interface. The processor may be a general-purpose central processing unit or a combination of a central processing unit and a graphics processing unit. The server executes an operating system, for example a UNIX-like operating system, and application software implemented in a high-level programming language such as Python. The server further executes software libraries for natural language processing and machine learning, including but not limited to a tokenization and linguistic analysis library and a numerical computation and neural network library.

The terminal includes a processor, a display, an input device, and a communication interface. The terminal runs a client application that communicates with the server over a network using a secure protocol. The user operates the terminal to interact with a communication application and with the client application that accesses the server.

The server acquires conversation history data from a communication application associated with the user. The server uses authentication information, such as an access token obtained via an authorization protocol, to call an application programming interface exposed by the communication application. The server receives conversation history data in a structured data format that includes message content, sender and recipient identifiers, timestamps, and metadata such as message type. The server stores the conversation history data in a persistent storage device with a defined schema. For example, the server stores each message as a record containing fields for message text, time information, and a user identifier.

The server preprocesses message content contained in the conversation history data. The server converts all characters in the message text to a normalized form, such as lowercasing alphabetic characters and mapping variant forms of characters to a canonical representation. The server removes unnecessary symbols that are not required for language analysis, including decorative punctuation, control characters, and certain markup tags. The server segments the message text into words or tokens using a tokenization algorithm that operates on the character sequence and language-specific rules. The server removes function words that carry little semantic weight for the purposes of style and topic analysis, based on a predefined list or a statistical criterion. The server concatenates the remaining tokens into standardized text data, and stores the standardized text data in association with corresponding message identifiers and timestamps.

The server generates feature data from the standardized text data. The server calculates word frequency information by counting occurrences of each token across the user's messages and optionally normalizing the counts. The server calculates phrase sequence frequency information by constructing n-grams of tokens and counting their occurrences. The server represents messages using a document-term matrix in which rows correspond to messages and columns correspond to tokens or n-grams, and entries contain frequency values or weighted values such as term frequency-inverse document frequency scores.

The server computes topic distribution information by applying a topic modeling algorithm implemented using a neural network library. In one embodiment, the server uses an autoencoding architecture or a neural topic model that receives the document-term matrix as input and outputs topic distribution vectors. The server represents each message as a vector of topic probabilities, and aggregates topic distributions across messages to obtain topic tendencies of the user.

The server computes writing style information by analyzing features such as average sentence length, distribution of parts of speech, frequency of particular syntactic patterns, and usage of characteristic phrases. The server extracts these features using natural language processing tools that perform part-of-speech tagging and shallow parsing. The server represents writing style information as numerical vectors that can be combined with topic and frequency information.

In some embodiments, the server also computes emotion feature information. The server applies an emotion classifier implemented as a neural network, for example a multilayer perceptron, recurrent neural network, or transformer-based classifier, which takes as input an embedded representation of the standardized text data and outputs scores for one or more emotion categories such as positive, negative, neutral, or more granular emotions. The server uses a loss function such as cross-entropy during training of the emotion classifier, and updates model weights by backpropagation and gradient descent. In deployment, the server uses the trained classifier to assign emotion scores to each message and aggregates these scores to form emotion feature information at the user level.

The server constructs a learning model using an unsupervised learning algorithm based on the feature data. In one embodiment, the server implements an autoencoder neural network that receives concatenated feature vectors (including word frequency information, phrase sequence frequency information, topic distribution information, writing style information, and optionally emotion feature information) as input. The autoencoder includes an input layer whose dimension matches the feature vector length, one or more hidden layers with decreasing dimension to form a bottleneck, and one or more decoder layers that reconstruct the input. The server uses a reconstruction loss function, such as mean squared error, between the input feature vector and the reconstructed feature vector. The server performs minibatch training, where each batch consists of a plurality of user-specific or message-specific feature vectors, and updates network weights using an optimization algorithm such as Adam. The bottleneck layer output serves as a compact representation of the user's style. The server stores the output of this bottleneck layer as a user style representation, which is an embedding vector summarizing language usage tendencies, conversation topic tendencies, and optionally emotional tendencies of the user.

In another embodiment, the server uses a clustering algorithm in combination with the autoencoder. The server first trains the autoencoder as described, then applies a clustering algorithm such as k-means to the embedding vectors to identify clusters of similar user styles or message styles. The cluster assignments can be used as additional discrete features within the user style representation, enabling the server to condition response generation on both continuous and discrete style indicators. This multi-stage approach improves numerical stability and allows efficient lookup of similar styles.

The server uses the user style representation to generate a style-aware prompt sentence for a generative AI model. The server converts numerical style information into textual descriptors. For example, when the topic distribution information indicates strong weight on project-related topics, the server generates a description such as “the user frequently talks about project progress, deadlines, and client meetings.” When the emotion feature information indicates a generally positive tone, the server adds a description such as “the user usually expresses opinions in a positive tone.” The server concatenates such descriptions with instructions and with the actual prompt sentence received from the user to form a style-aware prompt sentence.

As one example, when the user inputs the following prompt sentence at the terminal:
“Tell me about my recent work topics.”
   the server generates a style-aware prompt sentence such as:
“You are a generative AI model that responds in the user's typical style. The user frequently talks about project progress, deadlines, and client meetings, and usually uses concise and polite expressions. Based on this style, generate a natural response to the following user input: ‘Tell me about my recent work topics.’”

In another example, when the user inputs the following prompt sentence:
“Summarize what I've been chatting about with my friends lately.”
   the server may generate a style-aware prompt sentence such as:
“You are a generative AI model that responds in the user's typical style. The user often talks with friends about weekend activities, movies, and travel plans in a casual and friendly manner. Based on this style, generate a natural response to the following user input:
‘Summarize what I've been chatting about with my friends lately.’”

The server causes a generative AI model to receive, as conditioning information, the user style representation in the form of an embedding vector and, optionally, explicit topic information. In one embodiment, the generative AI model is a transformer-based neural network with an encoder-decoder architecture or an autoregressive decoder architecture. The server maps the embedding vector to additional key and value vectors that are injected into the attention mechanism of the transformer. For example, the server passes the embedding vector through a projection layer to obtain style-specific attention biases, and the generative AI model uses these biases to modify the attention distribution over tokens during decoding. This hardware-executed integration at the attention layer reduces the need for the model to infer style from scratch for each prompt and improves convergence of the decoding process.

In another embodiment, the server concatenates a tokenized representation of the user style representation to the beginning of the input sequence, thereby forming a combined sequence including style tokens and prompt tokens. The generative AI model processes the combined sequence and generates response candidates that are influenced by the style tokens. The server selects a temperature value, top-k or top-p sampling parameters, and a maximum token length for decoding. These parameters are chosen to balance diversity and consistency in generated responses while maintaining computational efficiency.

The server generates multiple response candidates by invoking the generative AI model with the style-aware prompt sentence and the conditioning information. The server calculates similarity scores between each response candidate and the user style representation. In one embodiment, the server embeds the response candidate into the same vector space as the user style representation using an auxiliary encoder network. The server then computes a distance measure, such as cosine similarity or Euclidean distance, between the response candidate embedding and the user style representation. The server selects response candidates whose similarity exceeds a threshold or ranks candidates by similarity and selects the highest-ranked candidate. This explicit numerical comparison enables the server to enforce alignment between generated responses and the user style representation.

The terminal presents one or more selected response candidates to the user on a graphical user interface. The user reviews the response candidates and selects one candidate. The terminal sends the selected candidate to the server, and the server transmits the selected candidate via the communication application, thereby adding it to the conversation as if it were typed by the user. The server may also log the selected response for further training or adaptation of the learning model.

This system provides technical effects on the functioning of the computer and network. By performing structured preprocessing and feature extraction, the server converts unstructured conversation text into compact, standardized feature vectors. Because the server stores user style representations as low-dimensional embeddings, subsequent response generation requests can be processed without re-analyzing the entire conversation history. This reduces processor cycles and memory bandwidth consumption during generation. The use of an explicit autoencoder-based bottleneck separates style inference from response generation, offloading style learning to a dedicated neural network trained offline or asynchronously. As a result, the generative AI model can operate with shorter context windows and fewer internal computations, improving throughput and reducing latency.

The integration of the user style representation into the attention mechanisms or input tokens of the generative AI model reduces redundant computation for style inference and improves numerical stability of decoding. Because the model receives structured conditioning information, the server can operate with a smaller or less resource-intensive generative model while achieving comparable or better style fidelity. This leads to reduced power consumption on the server hardware and allows deployment on systems with constrained computational resources. Additionally, by quantifying and filtering response candidates based on similarity to the user style representation, the server reduces the number of invalid or inappropriate responses, thereby lowering the need for additional post-processing and further conserving computational resources.

The described architecture is not a mere automation of human reply composition. A human cannot perform the described operations, such as constructing and updating high-dimensional embedding vectors, running autoencoder training with gradient-based optimization, or injecting style embeddings into attention layers, without the specialized numeric and logical capabilities of the server's processor and associated hardware. The system applies non-conventional data structures, including document-term matrices, topic distribution vectors, and embedding vectors, and non-conventional processing sequences, including unsupervised encoding of user style followed by style-conditioned generation and similarity-based candidate selection. These elements cooperate to improve the way the server processes and manages text data, leading to improved accuracy, speed, and resource efficiency of the computer system itself.

Various modifications and alternative configurations are possible. In one variation, the server uses a variational autoencoder instead of a standard autoencoder to form the user style representation, and employs a Kullback-Leibler divergence term in the loss function to regularize the latent space. In another variation, the server employs a contrastive learning objective, where positive pairs consist of messages from the same user and negative pairs consist of messages from different users, thereby encouraging the model to learn user-specific embeddings. In yet another variation, the server uses different natural language processing libraries or different neural network frameworks, provided that equivalent preprocessing, feature extraction, and model training functionalities are implemented. In some embodiments, the server periodically updates the learning model and user style representations as new conversation history data is collected. The server may employ incremental learning techniques to update weights without retraining from scratch, thereby maintaining real-time adaptability while controlling computational load. In other embodiments, the server maintains multiple user style representations for different contexts, such as professional conversations and personal conversations, and dynamically selects or interpolates between these representations based on the topic distribution of recent messages. By using these specific data structures, algorithms, neural network architectures, and integration methods, the system achieves concrete improvements in response generation quality, computational efficiency, and system stability. The described embodiments support the claimed subject matter and enable a person skilled in the art to implement the invention using known hardware and software components configured in the manners disclosed above.

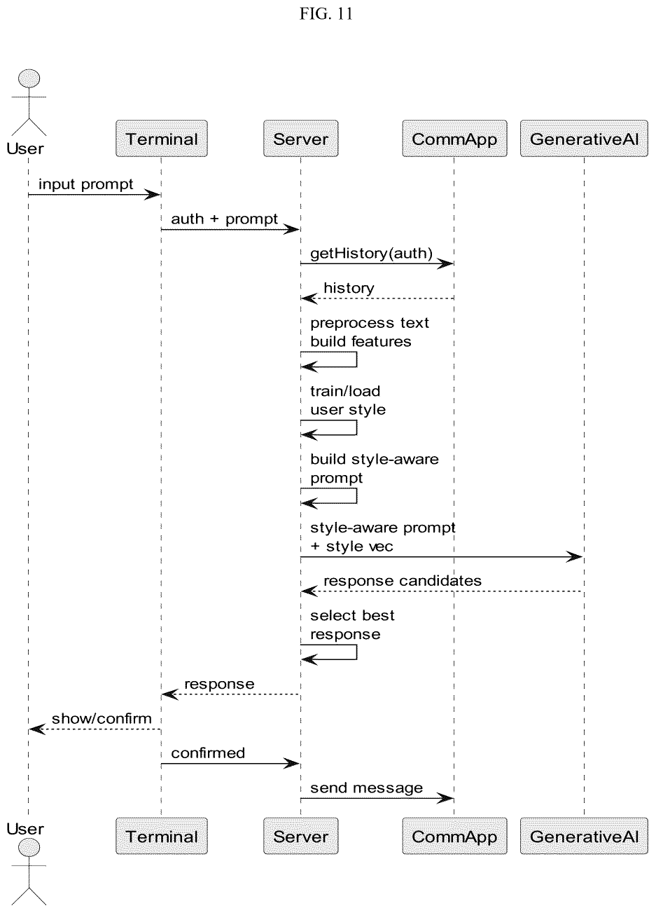

The following describes the processing flow using FIG. 11.

### Step 1:

The user operates the terminal to grant access permission. The user opens a communication application and an associated client application on the terminal and approves a permission screen to allow the server to access conversation history. As input, the user provides authentication consent and login information (for example, username, password, or authorization confirmation). As output, the terminal obtains an authentication token or authorization code from the communication application.

### Step 2:

The terminal transmits authentication information to the server. As input, the terminal uses the authentication token, user identifier, and application identifier obtained in Step 1. The terminal packages these values into a structured request and sends the request to the server over a secure communication protocol. As output, the server receives a request that contains sufficient information to access the user's conversation history via an application programming interface.

### Step 3:

The server acquires conversation history data from the communication application. As input, the server uses the authentication token and user identifier received from the terminal. The server calls an application programming interface exposed by the communication application, specifying parameters such as user ID, time range, and maximum number of messages. The server performs data operations that include sending a request, receiving a structured response, and verifying response codes. As output, the server obtains conversation history data including message content, sender and recipient identifiers, timestamps, and metadata, and stores this data in persistent storage in a defined record format.

### Step 4:

The server extracts message content and time information from the conversation history data. As input, the server uses the stored conversation history records from Step 3. The server parses each record, reads message text and corresponding time information fields, and discards irrelevant metadata such as internal identifiers or system notification flags. The data processing includes iterating over message records, mapping fields to an internal schema, and filtering by message type. As output, the server produces a structured dataset containing pairs of message text and time information associated with the user.

### Step 5:

The server performs text normalization as part of preprocessing. As input, the server uses the message text extracted in Step 4. The server converts all characters to a standardized representation (for example, converting uppercase letters to lowercase and mapping variant characters to canonical forms), removes unnecessary symbols such as decorative punctuation, special markers, and control characters, and collapses multiple spaces into a single space. The data operations include character-wise scanning, pattern matching, and string replacement. As output, the server generates normalized text strings corresponding to each original message.

### Step 6:

The server performs word segmentation and function word removal. As input, the server uses the normalized text from Step 5. The server applies a tokenization algorithm to split each text string into tokens according to language-specific rules, and then compares each token against a predefined list of function words. The server removes tokens that match the function word list, and may apply additional filters such as minimum token length. The data operations include lexical analysis, list membership checks, and token filtering. As output, the server generates standardized text data represented as sequences of content-bearing tokens for each message.

### Step 7:

The server builds a document-term representation. As input, the server uses the token sequences from Step 6. The server assigns an index to each distinct token and constructs a matrix in which rows correspond to messages and columns correspond to tokens. The server computes frequency values or term frequency-inverse document frequency scores for each token-message pair by counting occurrences and applying weighting formulas. The data operations include counting, normalization, and matrix population. As output, the server obtains a document-term matrix that numerically represents the standardized text data.

### Step 8:

The server generates frequency-based feature data. As input, the server uses the document-term matrix from Step 7. The server calculates word frequency information by summing token counts or weighted values across messages for each token, and calculates phrase sequence frequency information by constructing n-grams from token sequences and counting their occurrences. The server may normalize frequencies by total token count or by document length. The data operations include vector summation, n-gram generation, and frequency aggregation. As output, the server produces frequency vectors that describe word and phrase usage patterns for the user.

### Step 9:

The server computes topic distribution information. As input, the server uses the document-term matrix from Step 7. The server applies a topic modeling algorithm implemented in a neural network or probabilistic framework to infer latent topics. The server feeds the document-term matrix into the topic model, runs iterative optimization or inference steps, and obtains, for each message, a distribution over topics. The data operations include matrix multiplication, non-linear activation, and iterative parameter updates for the topic model. As output, the server generates topic distribution vectors for each message and aggregated topic tendencies for the user.

### Step 10:

The server computes writing style information. As input, the server uses the standardized text data from Step 6. The server runs linguistic analysis to assign part-of-speech tags and identify sentence boundaries, and then calculates statistics such as average sentence length, distribution of parts of speech, and frequency of specific syntactic patterns or characteristic phrases. The data operations include tagging, parsing, counting, and averaging. As output, the server produces numerical feature vectors that characterize the user's writing style.

### Step 11:

The server optionally computes emotion feature information. As input, the server uses the standardized text data from Step 6. The server passes embedded representations of messages through a trained emotion classification model and obtains scores corresponding to emotion categories. The server aggregates or averages these scores over multiple messages. The data operations include vector embedding, matrix multiplication, application of non-linear functions in the classifier, and numerical aggregation. As output, the server produces emotion feature information that reflects the emotional tendencies of the user's messages.

### Step 12:

The server constructs a combined feature vector. As input, the server uses the word frequency information, phrase sequence frequency information, topic distribution information, writing style information, and, when available, emotion feature information from Steps 8 to 11. The server concatenates these data elements into a single feature vector for each user or message, and normalizes the vector components as needed. The data operations include vector concatenation, scaling, and optional dimensional alignment. As output, the server generates a unified feature dataset that serves as input to a learning model.

### Step 13:

The server trains an unsupervised learning model to produce a user style representation. As input, the server uses the unified feature dataset from Step 12. The server defines a neural network model, such as an autoencoder, with an input layer matching the feature dimension, one or more hidden layers, and a bottleneck layer of reduced dimension. The server feeds batches of feature vectors into the model, computes a reconstruction loss between input and output, and updates model weights using an optimization algorithm. The data operations include forward propagation, loss calculation, backpropagation, and weight updates. As output, the server obtains trained model parameters and, by passing the user's feature vectors through the model, a user style representation in the form of an embedding vector.

### Step 14:

The server stores and manages the user style representation. As input, the server uses the embedding vectors and associated user identifiers from Step 13. The server writes the embedding vectors into a database or other persistent storage, indexed by user ID and optionally by context or time period. The data operations include indexing, insertion, and integrity checks. As output, the server maintains a retrievable mapping from each user to a corresponding user style representation for later use in response generation.

### Step 15:

The user inputs a prompt sentence at the terminal. As input, the user provides text describing a desired response, such as “Tell me about my recent work topics.” or “Summarize what I've been chatting about with my friends lately.” The terminal captures the text through an input interface and associates it with the current user account. As output, the terminal generates a request containing the raw prompt sentence and the user identifier.

### Step 16:

The terminal transmits the prompt sentence to the server. As input, the terminal uses the prompt sentence and user identifier from Step 15. The terminal packages these items into a structured request and sends the request to the server over a secure communication channel. The data operations include serialization of text and identifiers, encryption at the transport layer, and network transmission. As output, the server receives the request containing the prompt sentence.

### Step 17:

The server retrieves the user style representation. As input, the server uses the user identifier received from the terminal in Step 16. The server queries the storage that holds embedding vectors and reads the corresponding user style representation. The data operations include database lookup, index traversal, and data retrieval. As output, the server obtains the embedding vector and any associated topic or style metadata for the user.

### Step 18:

The server generates a style description based on the user style representation. As input, the server uses the user style representation from Step 17 and the underlying feature distributions derived during training. The server interprets high-weight dimensions in the topic distribution, frequent phrases, and style statistics to construct textual phrases such as “the user frequently talks about project progress, deadlines, and client meetings” or “the user often chats about weekend activities, movies, and travel plans.” The data operations include thresholding, ranking of feature values, and mapping to predefined descriptive templates. As output, the server produces a style description text that expresses key aspects of the user's style.

### Step 19:

The server constructs a style-aware prompt sentence. As input, the server uses the style description from Step 18 and the raw prompt sentence received in Step 16. The server concatenates instructions to the generative AI model, the style description, and the original prompt sentence into a single text. For example, the server constructs a text such as “You are a generative AI model that responds in the user's typical style. The user frequently talks about project progress, deadlines, and client meetings. Based on this style, generate a natural response to the following user input: ‘Tell me about my recent work topics.’” The data operations include string concatenation and insertion of the prompt sentence into a template. As output, the server generates a style-aware prompt sentence suitable for input to the generative AI model.

### Step 20:

The server prepares conditioning information for the generative AI model. As input, the server uses the user style representation from Step 17. The server passes the embedding vector through one or more projection layers or transformation functions to produce conditioning vectors compatible with the generative AI model's architecture, such as additional context embeddings or attention biases. The data operations include matrix multiplication, non-linear activation, and vector normalization. As output, the server produces conditioning information that numerically encodes the user style.

### Step 21:

The server invokes the generative AI model with the style-aware prompt sentence and conditioning information. As input, the server uses the style-aware prompt sentence from Step 19 and the conditioning information from Step 20. The server tokenizes the style-aware prompt sentence, converts tokens into embeddings, and supplies these embeddings along with the conditioning information to the generative AI model. The generative AI model processes the input sequence and generates multiple response candidates token by token according to its decoding strategy. The data operations on the server side include tokenization, embedding lookup, and invocation of the model interface. As output, the server receives one or more response candidates as text sequences.

### Step 22:

The server evaluates and selects response candidates based on the user style representation. As input, the server uses the generated response candidates from Step 21 and the user style representation from Step 17. The server encodes each response candidate into an embedding vector using an auxiliary encoder and compares this vector with the user style representation by computing a similarity measure such as cosine similarity. The server ranks candidates by similarity and optionally applies filters based on length, content, or safety rules. The data operations include embedding computation, similarity calculation, and ranking. As output, the server selects one or more response candidates that are most consistent with the user style representation.

### Step 23:

The server transmits the selected response candidate to the terminal. As input, the server uses the selected candidate or candidates from Step 22 and the user identifier. The server packages the selected response into a response message and sends it to the terminal via the established communication channel. The data operations include serialization of text, message formatting, and network transmission. As output, the terminal receives the selected response candidate for display.

### Step 24:

The terminal presents the selected response candidate to the user and forwards the user's selection. As input, the terminal uses the response candidate from Step 23. The terminal displays the candidate in a user interface where the user can approve or modify it. The user may simply accept the candidate as-is. The terminal captures the user's selection and sends a confirmation message to the server, indicating that this candidate should be used as the outgoing message. The data operations include user interface rendering, event handling, and transmission of confirmation. As output, the server receives confirmation of the selected response.

### Step 25:

The server transmits the confirmed response via the communication application. As input, the server uses the confirmed response candidate and the authentication information associated with the communication application. The server calls the communication application's sending interface, supplying the message text and necessary addressing parameters. The data operations include constructing a request to the communication application, sending the request, and handling any response codes. As output, the confirmed response becomes part of the conversation handled by the communication application, and the server may optionally log this event and update training data for future refinement of the user style representation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional communication support systems, recommendation logic and reply assistance are often implemented as static rule sets or simple keyword matching executed on generic processors. Such approaches typically treat user message history as a flat collection of strings and do not transform this data into richer internal representations that can be effectively consumed by advanced machine learning models. As a result, the system cannot efficiently exploit computational resources to generate high-quality, personalized recommendations in a scalable and repeatable manner.

Furthermore, in many existing architectures, natural language processing, user interest inference, and content recommendation are implemented as loosely coupled components without a coherent data flow optimized for machine execution. History acquisition, text preprocessing, interest classification, prompt generation for a generative AI model, and feedback utilization are often handled as ad hoc scripts or external services. This fragmented architecture leads to redundant data conversion, inefficient use of storage and memory, increased latency, and difficulty in systematically improving model performance. From a computer-technology perspective, these systems do not provide a structured mechanism by which a processor can transform raw communication logs into machine-interpretable feature representations and then into stable, reusable prompt sentences for a generative AI model.

In addition, existing systems generally fail to close the loop between user behavior on recommended items and subsequent internal processing. User interactions such as selection operations and viewing actions are either not captured at a granular level or are not reintegrated into the same computational pipeline that performs interest classification and prompt generation. This results in a lack of adaptive behavior at the system level: the processor cannot adjust interest representations, weighting, or prompt structures in response to observed behavior, and therefore cannot improve its future computational decisions in a systematic manner.

Moreover, generative AI models are frequently invoked with unstructured or weakly structured natural language prompts crafted manually by developers or end users. Such prompts often omit critical context such as categorized interest fields, required output size, machine-parsable output format, or search terms suitable for downstream content retrieval. Consequently, the processor cannot reliably control the behavior of the generative AI model, and additional parsing and post-processing are required, which increases computational overhead and reduces system determinism. This undermines the efficiency and robustness of the overall computer system.

Therefore, there is a need for a computer-implemented technique that improves the way a processor acquires and transforms user communication history into structured feature data, classifies user interest fields, generates structured prompt sentences for a generative AI model, and reuses user feedback for subsequent processing. Such a technique should enhance the internal operation of the computer system itself by optimizing data representations and processing sequences, thereby improving computational efficiency, scalability, and the quality and controllability of generated recommendations.

The specific processing by the specific processing unit 290 of the data processing device 12 in Application Example 1 is realized by the following means.

The present invention provides a server comprising a processor configured to acquire history information from a communication information processing program executed on a user communication information processing device, to extract character information from the history information and preprocess the character information by using a language processing information processing program to obtain a sequence of lexical units and frequent lexical units, to generate numerical feature quantities for the extracted lexical units by using a trained information processing model and classify an interest field of the user on the basis of the numerical feature quantities, to generate a structured prompt sentence for instructing a generative information processing model to generate or select related information on the basis of the classified interest field and the lexical units extracted from the history information, to input the prompt sentence to the generative information processing model and obtain a set of information items related to the interest field, to acquire additional information from an external information providing device on the basis of the set of information items and complement the information items to construct recommendation information, to transmit the recommendation information to a user communication terminal device in a displayable format, and to acquire a selection operation or a viewing action with respect to the recommendation information by the user and store the acquired action as part of the history information for reuse in subsequent classification and generation processing. This enables the computer system to internally transform unstructured communication logs into machine-interpretable feature representations, to control a generative AI model via structured prompt sentences, and to iteratively refine interest classification and recommendation generation based on user feedback, thereby improving computational efficiency, resource utilization, and the technical quality and controllability of personalized information recommendations.

The term “history information” refers to data representing past communication activities of a user in a communication environment, including at least textual message content and optionally associated metadata such as timestamps, conversation identifiers, and participant identifiers.

The term “communication information processing program” refers to a software component executed on a computing device that performs communication-related processing, including sending, receiving, or storing messages exchanged between users or between a user and a service.

The term “user communication information processing device” refers to a computing apparatus operated by or associated with a user, such as a terminal or server, that executes a communication information processing program and provides access to communication functions.

The term “character information” refers to text data obtained from history information, including sequences of characters, symbols, or encoded text that can be processed by a language processing function.

The term “language processing information processing program” refers to a software component or module configured to perform natural language processing on character information, including operations such as tokenization, morphological analysis, part-of-speech tagging, lemmatization, or filtering of stop words.

The term “lexical unit” refers to a basic linguistic element derived from character information, such as a word, token, term, or phrase, that is used as a unit of analysis in language processing and subsequent feature generation.

The term “frequent lexical unit” refers to a lexical unit that appears with a frequency exceeding a predetermined threshold or rank within history information for a user or within a collection of history information.

The term “trained information processing model” refers to a computational model, such as a statistical model or machine learning model, that has been trained on training data to generate outputs, such as numerical feature quantities or classification results, in response to input data.

The term “numerical feature quantities” refers to numerical values or vectors that represent properties of lexical units or groups of lexical units, and that are suitable for mathematical processing by a trained information processing model, such as embeddings, feature vectors, or weighted scores.

The term “interest field” refers to a category, topic, or area of interest inferred for a user, based on numerical feature quantities generated from the user's history information, and used to characterize the user's preferences with respect to information content.

The term “prompt sentence” refers to an instruction text provided as input to a generative information processing model, the instruction text specifying at least a context, a task, or constraints for generating or selecting information items.

The term “structured prompt sentence” refers to a prompt sentence having an internal structure that explicitly includes defined elements such as an interest field type, a required number of information items, an output format, or search terms, thereby enabling deterministic processing by a generative information processing model.

The term “generative information processing model” refers to a computational model configured to generate or select information items in response to an input, such as a prompt sentence, by using generative techniques including, for example, probabilistic modeling or neural network-based text generation.

The term “information item” refers to a unit of recommended content or a descriptor of such content, including at least a title, a summary, or an identifier that can be used to access or retrieve detailed information.

The term “external information providing device” refers to a system or service external to the server that supplies information data, such as content metadata, resource links, or descriptive information, in response to a query or request.

The term “recommendation information” refers to a set of one or more information items that have been constructed or refined on the basis of outputs from a generative information processing model and optionally additional information from an external information providing device, and that are intended to be presented to a user.

The term “user communication terminal device” refers to a terminal apparatus operated by a user, such as a smartphone, tablet, or personal computer, that can receive, display, and allow interaction with recommendation information transmitted from a server.

The term “displayable format” refers to a data representation of recommendation information that can be rendered on a user communication terminal device, including formats such as structured text, markup, or graphical elements suitable for a user interface.

The term “selection operation” refers to an explicit user input action indicating a choice with respect to recommendation information, such as tapping, clicking, or otherwise activating a displayed item.

The term “viewing action” refers to user behavior related to the display or consumption of recommendation information, including actions such as opening, scrolling, or dwelling on an item, as detected or recorded by a device.

The term “classification result confidence level” refers to a numerical value or score that represents the degree of certainty with which a trained information processing model assigns an interest field to a user, based on numerical feature quantities.

The term “past selection history” refers to stored data indicating previous selection operations or viewing actions of a user with respect to past recommendation information, used as behavioral feedback for subsequent processing.

The term “presentation order” refers to an arrangement or sequence in which recommendation information is displayed to a user on a user communication terminal device.

The term “presentation presence” refers to whether recommendation information is displayed or not displayed to a user, based on weighting or other control logic applied by the processor.

In one embodiment, a server cooperates with a terminal operated by a user to implement a personalized information recommendation system based on a generative AI model and structured prompt sentences. The server includes at least one processor, a main memory, a non-volatile storage device, and a network interface. The server executes an operating system such as a general-purpose server operating system and application programs including a communication information processing program, a language processing information processing program, a machine learning program, and a generative model interface program. The terminal includes a processor, a memory, a display, an input interface, and a communication module, and executes a user communication application and a client program for sending and receiving data with the server.

The server stores, in the non-volatile storage device, a history information storage region, a feature data storage region, a model parameter storage region, and a recommendation information storage region. The history information storage region holds history information representing past messages and associated metadata obtained from the user communication application. The feature data storage region holds lexical units, numerical feature quantities, interest field classification results, and behavior feedback data. The model parameter storage region holds parameters for a trained information processing model and a generative information processing model interface, including weight matrices, bias vectors, and configuration parameters. The recommendation information storage region holds generated information items, enriched recommendation information, and presentation control data such as weights and ordering.

The server uses the language processing information processing program to perform natural language processing on character information contained in the history information. In one implementation, the server uses a natural language processing library such as spaCy running on a programming language runtime, and executes tokenization, part-of-speech tagging, and lemmatization on message text. The server treats each token or phrase as a lexical unit and applies stop-word filtering and frequency counting. The server then stores, in the feature data storage region, for each user, a list of lexical units, occurrence counts, and contextual statistics such as co-occurrence frequencies and document frequencies. This structured internal representation allows the server to avoid re-parsing raw strings in later stages and thus reduces redundant processing.

The server converts the lexical units into numerical feature quantities suitable for input to a trained information processing model. In one embodiment, the server uses a machine learning library such as TensorFlow and loads a neural network-based embedding model from the model parameter storage region. The server maps each lexical unit to a dense vector of real numbers representing semantic features. The server aggregates these vectors by applying operations such as weighted averaging, max pooling, or attention-based weighting across the user's history. The server stores the resulting user-level feature vector in the feature data storage region. Because the server uses compact floating-point vectors instead of sparse one-hot encodings or raw text, the memory bandwidth and computation time required for subsequent classification are reduced, and the server can process a large number of users with lower latency.

The server classifies an interest field of the user by applying the trained information processing model to the numerical feature quantities. In one example implementation, the trained information processing model is a feed-forward neural network with an input layer matching the dimension of the feature vector, one or more hidden layers with nonlinear activation functions, and an output layer representing probability values for multiple interest field categories. The server applies a softmax function at the output layer to obtain a probability distribution across categories. The server uses a cross-entropy loss function during training and updates weights by gradient descent or a variant such as Adam optimization. The server may use mini-batch training on historical labeled data, where each training instance is a user feature vector and a set of known interest categories. The server stores, in the model parameter storage region, the trained weights and biases. The server applies this trained model at run time to compute, from the user's feature vector, a classification result and associated confidence levels for each interest field. The server then writes the interest field identifiers and confidence scores into the feature data storage region.

The server generates a structured prompt sentence for a generative AI model using the classified interest field and the lexical units extracted from the history information. The server composes the prompt sentence by inserting category names, representative lexical units, a required number of information items, and an expected output format into a fixed template. The server thereby generates a prompt sentence that is structured and machine-oriented rather than an arbitrary free-form instruction. For example, the server may generate a prompt sentence such as:
“The user frequently discusses the following topics in chat: sci-fi movies, jazz music, and film soundtracks. The user's interest categories are: Movies, Music. Generate a list of 10 recommended contents (articles, videos, or playlists) related to these interests. For each item, provide: title, short description (maximum 30 words), content type (article, video, playlist), and a suggested search query. Output only the list of items.”

In another example, the server may generate a prompt sentence such as:
“Based on the user's chat history keywords [movie, sci-fi, cinema, jazz, soundtrack] and the identified categories {Movies, Music}, create 8 recommendation messages that could be shown in a messaging app. Each message should be 1-2 sentences and should briefly recommend a specific type of content, such as latest sci-fi movie reviews or new jazz album releases. Output as a numbered list.”

The server uses these structured prompt sentences to control the behavior of the generative AI model in a deterministic way. Because the prompt includes explicit constraints and structured elements, parsing of the model's response can be simplified, and the server can avoid heuristic post-processing in many cases. This reduces CPU usage and error-prone text interpretation and thereby improves overall system performance.

The server interfaces with a generative information processing model implemented on the same server or on a separate computing system accessible via a network interface. In one embodiment, the generative information processing model is a transformer-based neural network configured for natural language generation. The transformer includes multiple layers of self-attention and feed-forward sub-layers with learned parameters. The server sends the structured prompt sentence as input tokens to the model and receives generated tokens as output. The server then segments the generated text into individual information items based on predetermined delimiters, list markers, or simple pattern matching. The server interprets these information items as candidate recommendation descriptions and stores them in the recommendation information storage region.

The server enriches the candidate recommendations by acquiring additional information from an external information providing device such as a search service, a content catalog service, or another database system. The server uses the titles or suggested search queries generated by the generative information processing model as query terms. The server transmits these query terms via the network interface using standardized protocols and receives structured responses including resource identifiers, metadata, and content attributes. The server merges the metadata with generated descriptions and constructs recommendation information objects that include at least a title, a short description, a content type, and a resource locator. Because the server uses a combination of generative descriptions and authoritative external metadata, the recommendation information becomes both semantically rich and technically precise, improving the reliability and usefulness of the output.

The server transmits the recommendation information to the terminal. The server formats the recommendation information as structured data, for example as records containing fields for display text, category, ranking weight, and resource link. The server sends these records over a network connection using a communication protocol such as HTTPS. The terminal receives the recommendation information and stores it in a local memory or database. The terminal then converts the recommendation information into a displayable format using a user interface framework, such as a list view, tiles, or cards, and displays titles, summaries, and icons on the display. The terminal may group items by interest field and visually emphasize items with higher weights as computed by the server.

The user views the displayed recommendation information on the terminal and performs selection operations using touch input, pointing devices, or keyboard input. The terminal sends, back to the server, behavior feedback including identifiers of selected items, timestamps, dwell time, and scrolling behavior. The server stores the feedback as additional history information. The server later uses this augmented history information as part of the input when extracting lexical units and generating new feature vectors. The server may also adjust classification thresholds or reweight existing feature vectors according to the observed behavior, thereby reinforcing interest fields that are confirmed by user actions and reducing the influence of misclassified interests. This closed-loop feedback mechanism enables the server to continuously adapt its internal representations in a manner that is not merely a direct automation of manual selection but a dynamic optimization of feature representations and model parameters.

The server controls presentation order and presence of recommendation information by assigning a weight to each recommendation item. The server calculates the weight based on the confidence level of the interest field classification, the past selection history of the user, and additional rules. For example, the server can multiply the interest field probability by a historical click-through rate for similar items and by a recency factor that decays over time. The server then sorts the recommendation information according to the calculated weights and may suppress items whose weight falls below a threshold. This algorithmic arrangement reduces the number of low-relevance items transmitted to the terminal, thereby decreasing network traffic and lowering the rendering load on the terminal, while maintaining or increasing the relevance of the displayed items.

The server improves computer technology in several ways. First, by transforming unstructured text into compact numerical feature vectors and storing them in a dedicated feature data storage region, the server reduces the amount of data that must be processed at inference time. This yields faster classification and prompt generation for large user bases. Second, by generating structured prompt sentences that encode machine-interpretable constraints, the server enables the generative information processing model to produce more predictable and parseable outputs. This directly reduces parsing errors and the need for expensive post-processing. Third, by integrating behavior feedback into the same computational pipeline used for feature generation and classification, the server performs model adaptation that is tightly coupled with the internal data structures of the system, leading to improved accuracy of interest field classification and better allocation of computational resources. These improvements go beyond simple automation of human recommendation tasks and instead modify how the computer organizes, stores, and processes data.

The server uses specific training procedures to obtain the trained information processing model. In one embodiment, the server constructs a training dataset by aggregating historical lexical unit vectors and manually or semi-automatically labeled interest categories. The server divides the dataset into training and validation subsets, computes a forward pass through the neural network to obtain predicted category probabilities, and calculates the cross-entropy loss with respect to ground-truth labels. The server updates weights by applying backpropagation and a gradient-based optimizer across multiple epochs until the validation loss converges or a stopping criterion is met. The server may apply regularization techniques such as dropout or weight decay to avoid overfitting. The server may also perform data augmentation on lexical units, such as synonym replacement or phrase reordering, to increase the robustness of the feature representation against variations in user language. All model parameters resulting from this training procedure are stored in the model parameter storage region and loaded into memory when the server performs classification at run time. The server can be configured to use alternative model architectures. In a first variation, the server uses a convolutional neural network over sequences of lexical unit vectors to capture local n-gram patterns in user messages. In a second variation, the server uses a recurrent neural network or a gated recurrent unit to model temporal dependencies across the message history. In a third variation, the server uses a transformer encoder to process entire message sequences, with attention weights indicating which parts of the history contribute most to the interest classification. In each case, the server stores intermediate representations in an internal buffer and writes only the final user-level feature vector to the feature data storage region, thus limiting the memory footprint while leveraging structured sequence modeling. These variations show that the system is not confined to a single abstract model but can adopt multiple concrete neural architectures while maintaining the structured data flow defined in the claims.

The terminal may likewise implement different user interface configurations while remaining within the scope of the embodiment. In one example, the terminal executes a native application that displays recommendation information in a scrollable list and reports fine-grained user interactions. In another example, the terminal operates as a web client executing script code that renders recommendation information obtained from the server and sends interaction events via asynchronous network requests. In both cases, the terminal acts as a controlled endpoint that not only displays content but also supplies structured feedback data to the server, enabling the server to further refine its models and data structures.

The server can also manage multiple users and multiple terminals. The server partitions history information, feature vectors, and recommendation data by user identifier and can process requests in parallel by using a multi-core processor or a cluster of servers. The use of compact feature vectors and structured prompts allows the server to schedule batch classification and prompt generation operations efficiently. Because the processing logic is based on explicit data structures and algorithms, as described above, the system scales with increased load while maintaining low response times and high classification accuracy. Through these configurations, the server, the terminal, and the user cooperate in a technical system where raw communication logs are converted into structured internal representations, processed by specific algorithms and neural network models, and used to generate and present recommendation information. The server thereby improves the functioning of the computer system itself, including data management, computation efficiency, and control over generative AI behavior, rather than merely automating manual content selection by the user.

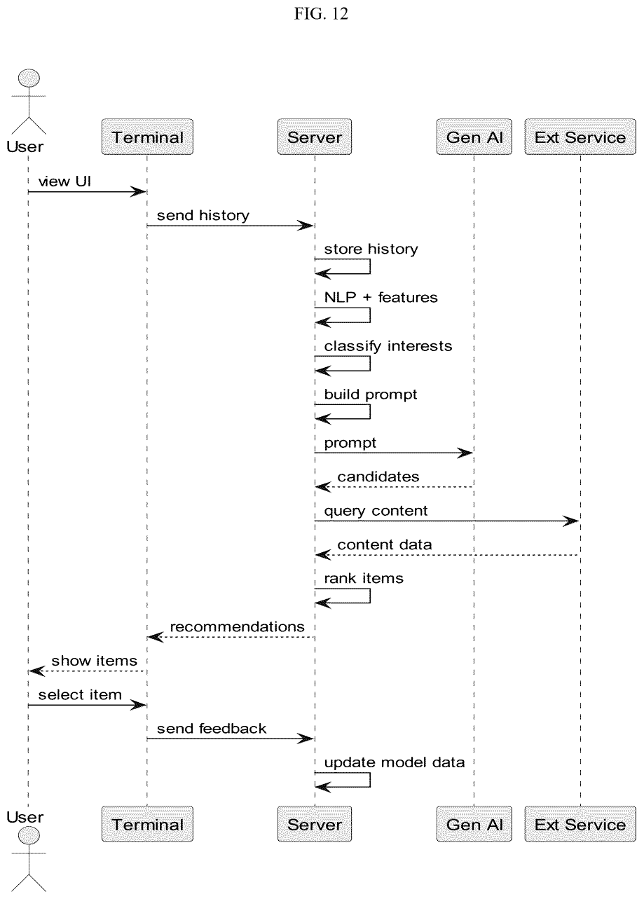

The following describes the processing flow using FIG. 12.

### Step 1:

The terminal collects communication history from a user communication application and prepares it for transmission. The terminal reads stored message records, including at least text bodies, timestamps, and conversation identifiers, from a local storage structure or an application-provided interface. As input, the terminal uses raw message objects maintained by the communication application. The terminal filters out non-text content such as images or files, extracts only the character strings and associated metadata, and converts them into a structured data representation such as a list of records containing fields for user identifier, message text, time, and conversation identifier. As output, the terminal generates a normalized history dataset ready to be sent to the server.

### Step 2:

The terminal transmits the normalized history dataset to the server over a communication network. As input, the terminal uses the normalized history dataset produced in Step 1. The terminal encapsulates the dataset into a request payload and sends it to a predefined server endpoint using a secure transport protocol. The terminal waits for an acknowledgment from the server and may retry or buffer the data if transmission fails. As output, the terminal produces a network message containing the history dataset, and, upon receiver confirmation, generates a local status indicating successful upload.

### Step 3:

The server receives and stores the history information from the terminal. As input, the server uses the network message containing the normalized history dataset. The server validates the structure of the received data, checks user identifiers, and removes any malformed entries.

The server then writes the valid history records into a history information storage region in a database or structured storage system, indexing them by user identifier and timestamp. As output, the server produces stored history entries that can be efficiently retrieved for language processing.

### Step 4:

The server extracts character information from the stored history and performs language preprocessing. As input, the server uses the stored history entries for a given user, including message text fields. The server invokes a language processing program to segment the text into tokens, assign part-of-speech tags, and perform lemmatization. The server removes stop words, punctuation, and irrelevant symbols, and counts occurrences of each remaining token. The server then stores lexical units, their lemma forms, and frequency counts in a feature data storage region. As output, the server generates a list of lexical units with associated frequencies and linguistic attributes for that user.

### Step 5:

The server computes numerical feature quantities from the lexical units using a trained model. As input, the server uses the list of lexical units and their frequencies generated in Step 4. The server looks up or computes an embedding vector for each lexical unit based on parameters stored for a trained embedding model. The server may weight each vector by its normalized frequency or by a measure such as term frequency-inverse document frequency. The server aggregates these weighted vectors using a mathematical operation, such as averaging, summation, or pooling, to obtain a single feature vector representing the user's interest profile. As output, the server produces a compact numerical feature vector associated with the user.

### Step 6:

The server classifies the user's interest fields using a trained classification model. As input, the server uses the numerical feature vector produced in Step 5. The server feeds this vector into a neural network classifier whose parameters are stored in a model parameter region. The server performs matrix multiplications and applies activation functions layer by layer, and finally applies a softmax or similar normalization to obtain probability values for multiple interest categories. The server compares these probabilities with predetermined thresholds to select one or more interest fields for the user and records the associated confidence levels. As output, the server generates a classification result that includes identified interest fields and their confidence scores.

### Step 7:

The server generates a structured prompt sentence for a generative AI model based on the classification result and lexical units. As input, the server uses the identified interest fields from Step 6 and representative lexical units from Step 4, such as top-ranked tokens by frequency or relevance. The server inserts the category names, key lexical units, a required number of recommendation items, and an expected output structure into a predefined text template. The server may also include constraints such as maximum length for descriptions and types of content to be generated. As output, the server produces a structured prompt sentence that specifies to the generative AI model how many items to generate, what topics to cover, and how to format the response.

### Step 8:

The server submits the structured prompt sentence to the generative AI model and obtains candidate recommendation descriptions. As input, the server uses the structured prompt sentence generated in Step 7. The server encodes the prompt into tokens and sends it to a generative model execution environment, which may be local or remote. The server then receives a generated text response and segments it into separate recommendation descriptions using delimiters, numbering, or other recognizable patterns. The server discards any extraneous commentary and keeps only text segments that match required fields such as titles and short descriptions. As output, the server produces a set of candidate information items that describe content potentially relevant to the user's interest fields.

### Step 9:

The server enriches the candidate information items using an external information providing device. As input, the server uses the candidate information items obtained in Step 8, specifically their titles and suggested search terms. The server issues queries to one or more external services, sending search terms and receiving structured responses such as lists of available content objects with identifiers, URLs, and metadata. The server matches generated descriptions to returned content objects and merges fields such as official titles, resource links, thumbnails, or publication dates with the generated text. As output, the server produces enriched recommendation information objects that combine generated descriptions with concrete access information for real resources.

### Step 10:

The server assigns weights and determines a presentation order for the enriched recommendation information. As input, the server uses the enriched recommendation information created in Step 9, the classification confidence levels from Step 6, and past selection history stored in the feature data storage region. The server computes a weight for each recommendation item using a function that may multiply or otherwise combine category confidence, historical click-through probabilities for similar items, and temporal recency factors. The server sorts the recommendation items according to these weights and may filter out items whose weights fall below a preset threshold. As output, the server generates an ordered and possibly pruned list of recommendation information items, each with an associated weight.

### Step 11:

The server transmits the ordered recommendation list to the terminal. As input, the server uses the ordered list of recommendation information items from Step 10. The server packages the items into a structured response, including fields needed by the terminal to display titles, summaries, and links, as well as the computed weights for possible visual emphasis. The server sends this response to the terminal using a network protocol and records transmission metadata such as time and size for monitoring. As output, the server produces a network response containing the recommendation list ready for user presentation.

### Step 12:

The terminal receives the recommendation list and presents it to the user in a displayable format. As input, the terminal uses the network response containing the ordered recommendation information items from Step 11. The terminal parses the structured data and maps each item to a visual component, such as a list entry or card, using a graphical user interface toolkit. The terminal arranges the items according to the provided order and may highlight items with higher weights using font size, color, or position. The terminal then renders the user interface on the display so that the user can view available recommendations. As output, the terminal produces a visual screen state containing interactive recommendation elements.

### Step 13:

The user inspects the displayed recommendations and performs selection or viewing actions. As input, the user uses the visual screen state presented by the terminal in Step 12. The user decides which item to open, taps or clicks a selected recommendation, scrolls through the list, or ignores certain items. The user's physical actions are captured by the terminal's input subsystem and translated into interaction events such as item selection, open events, and dwell time measurements. As output, the user produces a pattern of interactions that reflect interest or disinterest in individual recommendation items.

### Step 14:

The terminal records the user's interactions as feedback data and sends it to the server. As input, the terminal uses the interaction events generated in Step 13, including item identifiers, timestamps, duration of viewing, and any explicit actions such as liking or dismissing an item. The terminal aggregates these events into a feedback dataset associated with the user and the corresponding recommendation items. The terminal then transmits this feedback dataset to the server via a network request. As output, the terminal generates a feedback message that encapsulates user behavior in a form suitable for further analysis.

### Step 15:

The server incorporates the feedback data into the history information and feature computation pipeline. As input, the server uses the feedback message received from the terminal in Step 14. The server stores the feedback as additional history information linked to corresponding recommendation items and interest fields. The server may update frequency counts of lexical units associated with selected items, adjust weights used in the interest classification or presentation ordering, or flag certain items as highly relevant or irrelevant based on the feedback. The server then recomputes, at scheduled times or on demand, feature vectors and classification results using both original communication history and behavior feedback. As output, the server produces updated feature data and interest field classifications that will influence future prompt sentence generation and recommendation creation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern digital communication environments, users frequently interact through text-based communication software across various terminal devices. As the volume and velocity of such interactions increase, users are required to respond rapidly and naturally while maintaining a consistent personal conversation style. Conventional systems that generate automated replies generally apply generic template-based responses or use generative models without sufficient personalization. These approaches suffer from several technical limitations.

First, conventional systems often do not efficiently structure transmission and reception records into conversation units or response pairs suitable for machine learning, thereby forcing downstream components to operate on noisy, unnormalized data. This leads to increased processing latency and reduced accuracy in style imitation, especially when applied at scale on server-side infrastructures.

Second, known generative models, when used without explicit per-user style information and context-sensitive prompt construction, tend to produce replies that are inconsistent with the user's typical tone, length, and response patterns. The absence of a persistent style representation tied to user identification information forces the system to implicitly infer style on every request, resulting in redundant computation, increased resource utilization on the server, and degraded response times.

Third, prior solutions generally do not integrate emotional-tendency-aware control into the generation process in a systematic and machine-implementable way. Although some systems analyze sentiment, they do not tightly couple quantified emotional tendencies with dynamic modification of prompt sentences or output constraints. As a result, the generated replies may fail to reflect the user's emotional context and may reduce the perceived naturalness and appropriateness of automated replies.

Fourth, conventional architectures lack a clear separation between (i) the learning of user-specific style and response tendencies from historical data, (ii) the generation of prompt sentences optimized for a generative artificial intelligence model, and (iii) the post-processing of multiple reply candidates with explicit constraints on length and expression safety. This absence of a structured processing pipeline makes it difficult to optimize each stage independently and to improve system-level metrics such as throughput, latency, and quality consistency across many users.

Fifth, systems that allow users to directly control generative models through ad hoc instructions often treat user-entered instructions and style information as independent signals. Without a mechanism that programmatically combines user-entered instruction prompt sentences with persistent style information or parameter information, the system cannot reliably produce context-specific output that both adheres to the user's overall style and reflects the user's instantaneous intent.

Accordingly, there is a need for an improved computer-implemented system and server-side processing architecture that: (i) automatically structures and preprocesses transmission and reception records into training-ready datasets; (ii) learns and stores user-specific style information or parameter information in association with user identifiers; (iii) constructs, at runtime, prompt sentences that integrate conversation history, style information, and emotional tendencies; (iv) interacts with a generative artificial intelligence model to obtain multiple reply candidates; and (v) post-processes and delivers such candidates to terminal devices in a way that reduces processing overhead, improves reply quality and consistency, and enhances the overall performance and usability of automated reply assistance in communication software.

The specific processing by the specific processing unit 290 of the data processing device 12 in Example 2 is realized by the following means.

The present invention provides a server comprising a processor and a storage device, the processor being configured to execute instructions to acquire, from communication software executed on a terminal device, transmission and reception records of a user, to structure the transmission and reception records on a conversation unit or response-pair basis, and to store the structured transmission and reception records in the storage device; to remove symbol information, decoration information, and unnecessary information from the transmission and reception records, normalize variations in character representation of textual information, and format the transmission and reception records as a training data set including a correspondence relationship between utterances of the user and utterances of a communication partner; to input training instruction information to a generative artificial intelligence model based on the training data set so as to cause the generative artificial intelligence model to learn a conversation style and a response tendency of the user, to cause the generative artificial intelligence model to generate style information or parameter information reflecting a user-specific conversation style, and to store the style information or the parameter information in association with user identification information; to acquire a newly received message and conversation history information based on the transmission and reception records, and to generate, based on the style information or the parameter information, a prompt sentence for causing the generative artificial intelligence model to generate one or more reply candidates; to apply natural language processing to the conversation history information to detect emotional expressions including positive and negative expressions, to quantify an emotional tendency based on the emotional expressions, and to dynamically change style designation information or output constraint information in the prompt sentence based on the emotional tendency; to input the prompt sentence to the generative artificial intelligence model, to obtain, from the generative artificial intelligence model, a plurality of reply candidates that imitate the conversation style of the user, and to perform post-processing on the plurality of reply candidates including at least a length constraint and expression safety checking; and to transmit the post-processed plurality of reply candidates to the terminal device and to output information for causing the terminal device to allow the user to select at least one of the plurality of reply candidates, to accept an editing operation for a selected reply candidate, and to transmit an edited reply message via the communication software. This enables the server to implement an improved, computer-centric processing pipeline that efficiently converts raw transmission and reception records into user-specific style representations, constructs context-aware and emotion-sensitive prompt sentences for a generative artificial intelligence model, generates and filters multiple reply candidates with explicit constraints, and delivers editable, style-consistent automated replies to terminal devices, thereby improving the technical performance, scalability, and reliability of automated reply assistance in text-based communication environments.

The term “transmission and reception records” refers to electronic data representing messages transmitted from and received by a user through communication software, including at least textual content, identifiers of senders and recipients, time information, and conversation identifiers.

The term “communication software” refers to an application program executed on a terminal device that enables users to exchange messages over a communication network, including at least chat applications, messaging applications, and other text-based communication services.

The term “terminal device” refers to an electronic apparatus operated by a user and configured to execute communication software and interact with a server over a communication network, including at least mobile computing devices, portable computing devices, and stationary computing devices.

The term “storage region” refers to a logical or physical memory area provided by one or more storage devices and configured to store electronic data such as transmission and reception records, training data sets, style information, parameter information, and user identification information.

The term “symbol information” refers to characters or codes in message data that do not primarily convey linguistic content, including at least pictographic symbols, decorative symbols, and control characters.

The term “decoration information” refers to visual or stylistic elements in message data that modify the appearance of text without substantially altering the linguistic meaning, including at least formatting tags, style codes, and display-oriented markup.

The term “unnecessary information” refers to data elements in transmission and reception records that are not required for learning or generating user-specific reply candidates, including at least system messages, redundant metadata, and non-informative tokens.

The term “training data set” refers to a collection of structured data instances derived from transmission and reception records and formatted for use by a machine learning model, each instance representing at least an input utterance and a corresponding output utterance.

The term “correspondence relationship” refers to an association between an utterance of a communication partner and a subsequent utterance of the user that is treated as a response in a conversation context.

The term “utterance” refers to a unit of text-based expression in a communication session, including at least a single message or a logically contiguous group of messages produced by one party.

The term “communication partner” refers to an entity other than the user that participates in an exchange of messages with the user through communication software, including at least individual users and automated agents.

The term “generative artificial intelligence model” refers to a computational model configured to generate new data, including textual data, based on input data and learned parameters, such as probabilistic language models, neural network-based language models, and other generative models.

The term “training instruction information” refers to data provided to a generative artificial intelligence model for the purpose of adjusting or learning parameters, including at least formatted examples, prompts, and configuration settings derived from a training data set.

The term “conversation style” refers to one or more characteristics of how a user typically composes messages, including at least tone, formality level, typical length, lexical choice, and syntactic patterns.

The term “response tendency” refers to patterns in how a user typically responds to given types of incoming messages, including at least preferred reply structures, likelihood of acceptance or refusal, and typical temporal ordering of conversational moves.

The term “style information” refers to data representing one or more aspects of a user's conversation style and response tendency that are derived from training data and used to guide generation of reply candidates.

The term “parameter information” refers to numerical or symbolic values controlling the internal behavior of a generative artificial intelligence model, including at least model weights, bias values, and configuration parameters that have been adapted to reflect a user-specific conversation style.

The term “user identification information” refers to data used to uniquely or distinctively identify a user within a system, including at least identifiers, account information, and pseudonymous tokens.

The term “conversation history information” refers to data representing past utterances exchanged between the user and at least one communication partner in a conversation, ordered or otherwise organized according to time or conversational structure.

The term “prompt sentence” refers to a text or text-like instruction sequence supplied as input to a generative artificial intelligence model to specify a task, provide context, or constrain the form of generated output.

The term “emotional expressions” refers to linguistic elements in conversation history that convey affective states, including at least positive expressions and negative expressions indicating user sentiment or attitude.

The term “positive expressions” refers to textual elements that indicate favorable or affirmative emotional states, including at least words, phrases, or constructions associated with approval, happiness, or satisfaction.

The term “negative expressions” refers to textual elements that indicate unfavorable or adverse emotional states, including at least words, phrases, or constructions associated with disapproval, sadness, or dissatisfaction.

The term “emotional tendency” refers to a quantified or categorized representation of the distribution or dominance of emotional expressions in conversation history, indicating at least a relative balance between positive and negative affect.

The term “style designation information” refers to data included in or associated with a prompt sentence that specifies desired stylistic properties of generated text, including at least tone, politeness level, and formality.

The term “output constraint information” refers to data that specifies conditions or restrictions to be applied to text generated by a generative artificial intelligence model, including at least constraints on length, content categories, and expression types.

The term “length constraint” refers to a limitation on the size of generated text, including at least a maximum number of characters, tokens, or sentences.

The term “expression safety checking” refers to an automated process that evaluates generated text to detect and mitigate undesirable content, including at least harmful expressions, offensive language, and policy-violating content.

The term “reply candidate” refers to a piece of generated text that is proposed as a possible response to an incoming message and is subject to selection or editing by the user.

The term “instruction prompt sentence” refers to a prompt sentence that is directly input by the user to convey an explicit instruction or preference to the generative artificial intelligence model.

The term “input prompt sentence” refers to a prompt sentence that is provided to a generative artificial intelligence model as input for generation, including at least a combination of an instruction prompt sentence and style information or parameter information.

In one embodiment, a server, a terminal, and a user cooperate to implement the claimed system in a networked environment. The server executes program modules that run on general-purpose computer hardware, such as a multi-core central processing unit (CPU), system memory, non-volatile storage, and one or more graphics processing units (GPUs) for acceleration of deep neural network computations. The server operates under a general-purpose operating system, such as a UNIX-like operating system, and executes middleware such as a web application framework and a model-serving framework. The terminal is, for example, a smartphone, a tablet, or a personal computer executing communication software and a user interface module that interacts with the server over a packet-switched network. The server stores and executes an application that includes at least a communication history acquisition module, a preprocessing module, a training and style-learning module, a prompt construction module, an inference module, a post-processing module, and a reply distribution module. The server also cooperates with a storage subsystem, which may include a relational database system for structured data and a file or object store for model-related data and logs.

In a typical configuration, the server uses a relational database management system, such as a database engine that manages tables for message history, user profiles, model profiles, and configuration information. The server uses a model-serving framework capable of running a generative AI model, such as a transformer-based neural network. The generative AI model is, in one embodiment, a sequence-to-sequence language model having multiple layers of self-attention and feed-forward sub-layers, with learned parameters that represent statistical relationships between token sequences.

The server acquires transmission and reception records by communicating with communication software running on the terminal or with a communication backend associated with the communication software. The server receives message records that include at least text strings, user identifiers, partner identifiers, timestamps, and conversation identifiers. The server writes such message records into a message history table. The message history table contains, for example, columns for a primary key, a user identifier, a conversation identifier, a direction flag (sent or received), a message body, and a timestamp field. The server indexes this table on user identifiers and timestamps to allow efficient retrieval of chronological sequences.

The server preprocesses the transmission and reception records before they are used to train or adapt the generative AI model. The server executes text normalization routines that remove symbol information and decoration information and that standardize character encodings and Unicode variants. The server uses language-processing libraries or custom string-processing algorithms that operate on character arrays and token sequences. The server removes characters that match preconfigured classes, such as certain control characters, pictographs, and formatting tags. The server also normalizes variants of letters, digits, and punctuation into canonical forms to ensure that the model receives consistent tokenization, which improves training stability and reduces sparsity in the token distribution.

The server structures the preprocessed data into conversation units or response pairs. The server pairs each incoming message from a communication partner with a subsequent reply from the user when the time interval and conversation identifier satisfy predetermined conditions. The server thereby creates a training data set where each record includes an input utterance, a corresponding user reply, and metadata such as time difference and conversation context. The server stores this training data set in a separate table or file structure to maintain a clean separation between raw history and structured training data.

The server uses the training data set to adjust or generate style information and parameter information for the generative AI model. In one embodiment, the server performs a fine-tuning process on the generative AI model. The server transforms each input-reply pair into a supervised training example. For example, the server concatenates an instruction prefix with an incoming message and defines the user's reply as the target sequence. The server then feeds sequences of token identifiers into the transformer-based model. The model computes forward activations using attention mechanisms, where each attention head computes weighted sums of values vectors using similarity scores between query and key vectors. The server computes a loss value, such as cross-entropy between predicted token distributions and target tokens.

The server updates model parameters by backpropagating the loss through the transformer layers and applying an optimization algorithm, such as stochastic gradient descent with momentum or an adaptive gradient method. The server adjusts weight matrices in attention and feed-forward layers, as well as token embedding matrices and layer normalization parameters. The server executes these computations on a GPU or other accelerator to reduce training time. When the server completes the training or adaptation process, the server obtains a set of parameter values or an adapter module that reflects the user's conversation style and response tendencies.

In another embodiment, the server does not modify the base parameters of the generative AI model but derives style information, such as style vectors or conditional control tokens, from the training data. The server computes, for example, an average of hidden state vectors associated with the user's replies, clusters such vectors, and saves the resulting centroids as style representations. The server then stores an association between the user identifier and a style representation identifier in a model profile table. This approach allows the server to reuse a shared base model for multiple users while preserving user-specific style control with reduced memory overhead.

The server further executes an emotional analysis procedure on conversation history information. The server uses a classifier model or rule-based system that maps token sequences to sentiment labels or scores. For neural classification, the server may reuse part of the transformer architecture or a smaller classifier network. The server extracts features such as word-level embeddings, subword token embeddings, or sentence-level contextual embeddings computed in the model's hidden layers. The server applies a linear or non-linear projection to produce sentiment logits and then uses a softmax or similar function to obtain probabilities. The server aggregates such probabilities over multiple utterances and quantifies an emotional tendency as a numerical score or vector representing a distribution between positive and negative emotional states.

The server uses the style information, parameter information, and emotional tendency to construct prompt sentences at runtime. The server obtains a newly received message from the communication software and retrieves recent conversation history from the message history table. The server formats the history as text that explicitly labels utterances by speaker and orders them chronologically. The server then assembles a prompt sentence that includes a role instruction, style instructions, emotional or tone constraints, context lines, the newly received message, and generation directives.

For example, the server may construct a prompt sentence of the following form:
“You are a generative AI model that imitates this user's messaging style. Use casual and friendly language, and keep the reply short. Conversation so far:

Friend: I have been insanely busy this week.

User: That's tough. Don't push yourself too hard!

New incoming message: ‘Do you want to go out for drinks tonight?’

Generate 3 short and natural reply candidates that match the user's usual style.”

In another example, the server accepts a user-entered instruction prompt sentence and combines it with stored style information:
“Instruction: Generate a casual reply in Japanese that declines a friend's invitation for tonight, but clearly suggests meeting another day. Use the user's usual style.

New incoming message: ‘Do you want to go out for drinks tonight?’

Reply:”

The server selects which elements to include in the prompt sentence based on configuration parameters and the computed emotional tendency. For example, when the emotional tendency indicates strongly negative recent sentiment, the server may insert an explicit requirement to generate more supportive or gentle language. This dynamic modification of style designation information and output constraints directly alters the input space of the model, leading to different attention patterns and output token distributions.

The server submits the prompt sentence to the generative AI model in inference mode. The model receives the prompt as a sequence of tokens and computes hidden representations in each transformer layer. The model then generates reply candidate tokens autoregressively, at each step computing probability distributions for next tokens based on the encoded prompt and previously generated tokens. The server applies sampling or decoding strategies, such as top-k or nucleus sampling, and adjusts temperature parameters to control diversity and coherence. The server generates multiple reply candidates by repeating this decoding process with different random seeds or decoding parameters.

The server post-processes the generated reply candidates to enforce additional constraints. The server truncates sequences that exceed a maximum token or character length. The server applies a content filter that evaluates generated text using classification models or rule sets to detect disallowed expressions or unsafe content. If any candidate fails safety criteria, the server discards or modifies the candidate. The server optionally normalizes whitespace and punctuation in the generated text to ensure consistent display on the terminal. This post-processing improves the quality and safety of replies without requiring repeated interactions with the underlying generative model.

The server transmits the post-processed reply candidates to the terminal through an application-layer protocol. The terminal receives the reply candidates and displays them within the user interface of the communication software. The terminal may render each candidate as a selectable button or text element under the message input field. The user can select one of the candidates, modify it, or discard it. When the user selects a candidate, the terminal copies the text into an input widget and allows editing through a software keyboard. After editing, the terminal sends the final message to the communication backend, and the communication backend delivers the message to the communication partner.

In this architecture, the terminal is not merely a passive display device but also contributes to reducing network overhead and computational load. For example, the terminal can cache recently used or similar reply candidates and request only incremental updates from the server. The terminal can also provide feedback signals, such as which replies the user accepted, edited heavily, or rejected, which the server can log and optionally use to refine style information and parameter information over time.

The server implements the described modules and data flows using specific data structures and algorithms, which are designed to improve computer performance beyond simple automation of human decision-making. For example, by pre-structuring transmission and reception records into response pairs, the server reduces the complexity of later training and inference operations that would otherwise need to infer pairing on the fly, thus lowering computational overhead and latency. By maintaining user-specific style information and parameters in a separate database, the server can perform amortized learning operations and avoid repeated full re-analysis of entire histories at inference time. This persistent representation reduces redundant computations and improves throughput when serving many users concurrently.

Furthermore, the server uses specialized neural network architectures and training regimes to enhance generation accuracy and computational efficiency. The server may configure the transformer architecture with a number of layers, hidden dimensions, attention heads, and feed-forward dimensions that are tailored to typical message lengths and language properties of communication software texts. The server may employ learning-rate schedules, gradient clipping, and regularization to stabilize training. The server may also perform data augmentation on the training data set, such as random masking of tokens or permutation of neutral segments, to improve robustness to noise commonly found in casual text communication.

The server, by quantifying emotional tendencies and incorporating such numerical scores into prompt sentences or decoding constraints, performs a type of control over the generative process that is not easily achieved by human operators. The server adjusts internal decoding parameters or selects style control tokens based on computed emotion scores, which directly affects which tokens the model is likely to output. This technical linkage between computed features and decoding parameters results in measurable changes in output distributions, which can be evaluated in terms of sentiment alignment metrics and user satisfaction scores.

The described system improves data management by maintaining a normalized and indexed representation of message histories, style profiles, and emotional features. Because the server stores conversation units as structured records, retrieval and aggregation operations can be executed with efficient queries and require fewer I/O operations than ad hoc log scanning approaches. This improves responsiveness of the system when constructing prompt sentences for ongoing conversations.

The described architecture also reduces communication load between the server and terminal. The server transmits only compact reply candidates and identifiers, rather than raw training data or model parameters. The server executes computationally intensive operations, such as backpropagation and attention matrix multiplications, on specialized hardware in a centralized environment. The terminal executes lightweight user interface operations, minimizing energy consumption on portable devices.

In alternative embodiments, the server uses different forms of generative AI models, such as encoder-decoder transformers, recurrent neural networks with attention mechanisms, or hybrid models that combine rule-based preprocessing with neural generation. The server may store style information as discrete tokens, continuous vectors, or parameter sets, and may select among them dynamically based on current context. The server may also periodically re-train or adapt the generative AI model using new training data sets derived from more recent transmission and reception records, thereby updating style representations as the user's communication style evolves.

In another embodiment, the server implements a multi-stage generation process. The server first generates a coarse reply skeleton using a low-resolution model, then refines the skeleton using a higher-capacity model that incorporates detailed style and emotional constraints. This staged approach can reduce overall computation by limiting use of the most expensive components to shorter sequences, thereby improving throughput and reducing latency.

The system, through these configurations and variations, provides a technical improvement in how computing systems manage, analyze, and utilize communication histories to generate personalized, context-aware replies. The described modules, data structures, and neural network operations collectively result in faster response times, improved style and sentiment alignment, reduced error rates in reply generation, and more efficient use of computational and network resources. This improvement arises from the specific organization of server-side processing, the explicit construction and control of prompt sentences, the learned style and emotional representations, and the structured interaction with a generative AI model, rather than from a mere automation of human mental processes.

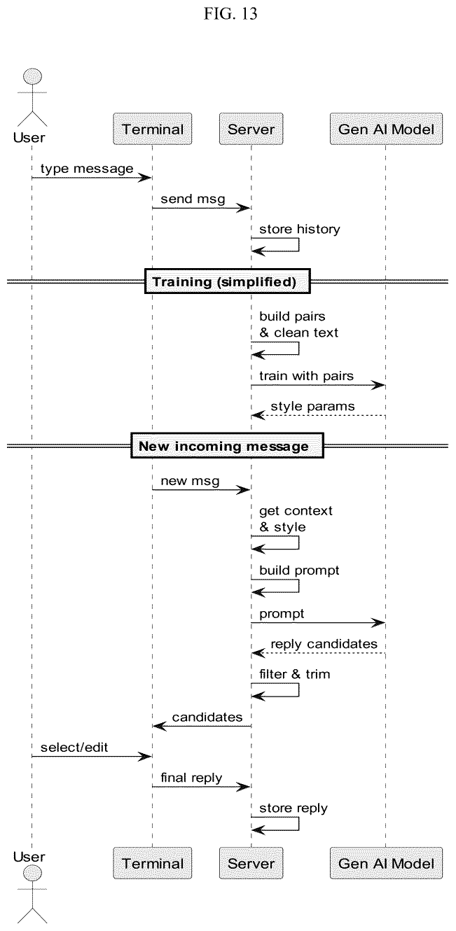

The following describes the processing flow using FIG. 13.

### Step 1:

The terminal acquires message data generated by the user and a communication partner through communication software. The terminal uses its communication software to capture each sent and received message, together with metadata such as a user identifier, a partner identifier, a conversation identifier, and a timestamp. As input, the terminal receives raw text entered by the user or received from the communication network. As output, the terminal produces structured message objects and transmits these message objects to the server via a network protocol.

### Step 2:

The server receives transmission and reception records from the terminal and stores them in a message history repository. As input, the server accepts the structured message objects containing text fields and metadata fields. The server writes these fields into a message history table in a database, assigning a primary key to each record and indexing the records by user identifier and timestamp. As output, the server generates persistent records that can be retrieved as chronologically ordered message sequences.

### Step 3:

The server structures the stored transmission and reception records into conversation units and response pairs. As input, the server reads a set of message records for a specific user and conversation identifier from the message history table. The server sorts the records by timestamp and groups them into sequences where each incoming message from a communication partner is paired with the next outgoing message from the user when a time interval condition is satisfied. The server generates response-pair records that contain at least an input utterance, a reply utterance, and associated metadata. As output, the server stores these response-pair records as a training data set in a separate storage region.

### Step 4:

The server preprocesses textual content in the training data set to normalize symbol information and decoration information. As input, the server obtains the input utterances and reply utterances from the response-pair records. The server applies string-processing routines that remove or replace non-linguistic symbols, control characters, and decorative markup, and that normalize character variants such as different width forms and encoded forms. The server tokenizes the text into a sequence of tokens based on a tokenizer compatible with the generative AI model. As output, the server produces cleaned and tokenized sequences for both input utterances and reply utterances, and associates these sequences with their corresponding response-pair records.

### Step 5:

The server derives emotional expressions and an emotional tendency from the conversation history information. As input, the server takes cleaned text segments from multiple messages associated with the user. The server applies a sentiment analysis algorithm implemented by a classifier model or rule set, which maps token sequences to sentiment categories and numerical scores. The server calculates sentiment features for each utterance, aggregates them over a defined time window, and computes an emotional tendency value that reflects the relative strength of positive and negative expressions. As output, the server stores emotional tendency values linked to the user and optionally to specific conversations.

### Step 6:

The server performs style learning and parameter adaptation for the generative AI model using the training data set. As input, the server uses pairs of cleaned token sequences representing incoming utterances and user replies. The server constructs supervised training examples where the input sequence includes the incoming utterance and an instruction prefix, and the target sequence includes the user reply. The server feeds the input tokens into a transformer-based generative AI model and performs forward propagation to compute predicted token distributions. The server then computes a loss value, such as cross-entropy between predicted distributions and target tokens, and performs backpropagation to calculate gradients with respect to model parameters. The server updates weights and biases in attention layers, feed-forward layers, and embedding matrices using an optimization algorithm. As output, the server obtains style information or parameter information that encodes the user's conversation style and response tendency and stores these in association with user identification information.

### Step 7:

The server generates a style profile for the user from the adapted parameters and training statistics. As input, the server takes intermediate representations such as average hidden state vectors for the user's replies, loss statistics, and emotional tendency values. The server aggregates these values, computes representative vectors or descriptors, and encodes them as style information entries. The server then associates these entries with the user identifier in a model profile repository. As output, the server maintains a style profile that can be accessed quickly when generating future replies for the user.

### Step 8:

The server acquires a newly received message and relevant conversation history information to prepare for reply generation. As input, the server receives a message notification or payload from the terminal or from a communication backend indicating a new incoming message for the user. The server retrieves recent message records belonging to the same conversation from the message history table and sorts them by timestamp. The server formats this recent history as human-readable text lines labeled by speaker, such as “Friend:” and “User:”. As output, the server produces a structured context object containing the new incoming message and its surrounding conversation history.

### Step 9:

The server constructs a prompt sentence for the generative AI model by combining the context object with the style profile and emotional tendency. As input, the server reads the new incoming message, recent conversation lines, the user's style information, and the latest emotional tendency values. The server composes a text string that includes a role instruction, style designation information, emotional constraints, the formatted conversation history, the new incoming message, and a generation directive. For example, the server may generate:
“You are a generative AI model that imitates this user's messaging style. Use casual and friendly language, and keep the reply short. Conversation so far:

Friend: I have been insanely busy this week.

User: That's tough. Don't push yourself too hard!

New incoming message: ‘Do you want to go out for drinks tonight?’

Generate 3 short and natural reply candidates that match the user's usual style.”

As output, the server obtains a finalized prompt sentence string suitable for input to the generative AI model.

### Step 10:

The user optionally inputs an instruction prompt sentence to refine generation behavior. As input, the user enters free-form text through a user interface on the terminal, such as:
“Generate a casual reply in Japanese that declines a friend's invitation for tonight, but clearly suggests meeting another day.”

The terminal sends this instruction text to the server. The server receives the instruction prompt sentence, combines it with the stored style information and the new incoming message, and constructs a composite input prompt sentence. As output, the server produces a revised prompt sentence that reflects both persistent style settings and the user's immediate instruction.

### Step 11:

The server inputs the prompt sentence to the generative AI model and generates one or more reply candidates. As input, the server converts the prompt sentence into token identifiers using the tokenizer associated with the generative AI model and sends these tokens to the model in inference mode. The model performs multiple layers of attention and feed-forward computations to encode the prompt and then autoregressively samples next-token probabilities to construct reply sequences. The server may set decoding parameters such as temperature, top-k value, and maximum token length to balance diversity and coherence. The server repeats this sampling process to obtain multiple distinct replies. As output, the server receives several generated token sequences, decodes them back into text strings, and associates each string with a candidate identifier.

### Step 12:

The server post-processes the generated reply candidates to enforce length and safety constraints. As input, the server takes the raw generated text candidates from the generative AI model. The server checks each candidate against a maximum length threshold and truncates candidates that exceed this limit. The server then applies safety filters, which may include keyword-based checks and classifier evaluations, to detect potentially harmful or inappropriate content. The server removes or replaces unsafe sections and, if necessary, discards entire candidates that cannot be safely corrected. The server normalizes whitespace, punctuation, and encoding to ensure consistent display. As output, the server produces a curated list of reply candidates that satisfy both length and safety requirements.

### Step 13:

The server transmits the curated reply candidates to the terminal for presentation. As input, the server uses the list of safe reply candidate strings and their identifiers. The server packages these candidates into a response payload and sends the payload through a communication interface to the terminal. As output, the terminal receives the payload and extracts the list of reply candidates.

### Step 14:

The terminal displays the reply candidates to the user within the communication software interface. As input, the terminal obtains the list of candidate strings and associated metadata from the server. The terminal renders each candidate as a selectable visual element, such as a button or a line of text below the input field. The terminal arranges these elements in a list or row and may label them as AI-generated suggestions. As output, the terminal presents an interactive display that allows the user to review and select any of the reply candidates.

### Step 15:

The user selects a reply candidate and optionally edits the content before sending. As input, the user views the candidates on the terminal display and taps one candidate that appears appropriate. The terminal then copies the selected candidate text into the message input area. The user may modify the text by adding or deleting characters or inserting additional phrases. As output, the terminal holds an edited reply message in the input area, ready for transmission.

### Step 16:

The terminal transmits the final edited reply message through the communication software and updates the display. As input, the terminal uses the text held in the input area when the user activates a send control. The terminal constructs a message object comprising the final text, the conversation identifier, and addressing information, and sends this object to the communication backend or server via the network. The terminal then updates the conversation view to show the newly sent message and any delivery status indicators. As output, the system records a new outgoing message in the conversation.

### Step 17:

The server receives the final edited reply message and updates internal data stores for future learning. As input, the server obtains the message object forwarded by the communication software or backend. The server inserts this message into the message history table with appropriate metadata, such as user identifier, conversation identifier, direction, and timestamp. The server may also create or update corresponding response-pair records by linking the new reply with its preceding incoming message. As output, the server augments the training data set with the new response pair, enabling future updates or refinements to the style information and parameter information for the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional messaging support systems that propose automatic replies typically rely on fixed templates or shallow pattern matching. Such systems do not build a persistent, machine-interpretable profile of a user's conversation style and emotional tendencies, and therefore cannot consistently generate reply candidates that accurately reflect the user's linguistic behavior. As a result, users must frequently edit or abandon suggested replies, which increases interaction cost and negates the benefit of automation.

In addition, many existing systems invoke a generative AI model with minimal or static input, such as only the latest message text, without encoding detailed context conditions including user-specific style, preferred length, or current emotion state. This under-utilizes the capabilities of the generative AI model and leads to unstable or mismatched outputs, thereby degrading the overall quality and reliability of automated replies.

Further, known techniques often return a flat list of generated replies in arbitrary order, without ranking or annotating the candidates based on compatibility with a learned user profile and a computed emotion state. In such cases, users are forced to manually scan multiple suggestions to find an acceptable one, which introduces latency and cognitive load. The absence of a feedback loop that learns from the user's actual selection and editing behavior further prevents the system from adapting over time.

Moreover, in multimodal or domain-specific scenarios, such as content recommendation tied to chat context or real-time customer service support, existing systems typically implement separate subsystems that are not coherently integrated with the reply-generation pipeline. For example, content recommendation may ignore the current emotional state inferred from communication history, and customer service assistance may not exploit a structured prompt sentence that encodes live context from a physical environment. This fragmentation results in inconsistent user experience and inefficient use of computational resources.

Accordingly, there is a need for an improved computer-implemented system that: (i) systematically acquires and structures communication history into user-level profile data capturing both conversation style and emotion state; (ii) constructs rich, context-aware prompt sentences that condition a generative AI model in a reproducible way; (iii) post-processes generated reply candidates using algorithmic evaluation and ranking aligned with the profile data; and (iv) incrementally updates the profile and ranking logic based on actual user behavior. Such improvements can reduce user editing effort, decrease end-to-end response latency, and enhance the technical performance and effectiveness of automated reply and recommendation functions in communication environments.

The specific processing by the specific processing unit 290 of the data processing device 12 in Application Example 2 is realized by the following means.

The present invention provides a server comprising a processor configured to acquire, based on user identification information, history data from communication processing software, to extract and store document data and attribute data from the history data, to execute natural language processing algorithms that preprocess the document data and calculate conversation style feature information, to execute emotion analysis algorithms that detect emotional expressions and generate quantified emotion state information, and to record, as profile data for each user, the conversation style feature information and the emotion state information; the processor further configured to receive, from a terminal device, a new message, to determine context information including writing style conditions, length conditions, and emotion conditions as reply candidate generation conditions based on the new message and the profile data, to generate a structured prompt sentence including the context information and the new message, and to input the prompt sentence as input data to a generative AI model to request a text generation process and to obtain a plurality of reply candidate texts; the processor further configured to evaluate the plurality of reply candidate texts by using the natural language processing algorithms and the emotion analysis algorithms, to calculate evaluation values based on conversation style compatibility, emotion consistency, and length suitability, to determine a presentation order of the plurality of reply candidates according to the evaluation values, and to transmit the plurality of reply candidates to the terminal device according to the presentation order so that the reply candidates are visually presented to a user and a selected reply candidate is transmitted as a message by the communication processing software; and the processor further configured to acquire usage history information including a selection result of the reply candidate and presence or absence of editing, and to update the profile data and evaluation conditions for determining the presentation order based on the usage history information. This enables the computing system to internally represent user-specific style and emotion as machine-processable profile data, to construct precise and context-rich prompt sentences that more effectively condition the generative AI model, to automatically filter and rank generated reply candidates in a manner aligned with the learned profile, and to adapt generation and ranking behavior over time based on real user feedback, thereby improving the technical performance, efficiency, and usability of automated reply and recommendation processing in communication environments.

The term “processor” refers to a data processing hardware element, such as a central processing unit or an execution core of an information processing apparatus, that is configured to execute program instructions to perform the functions described in the present disclosure.

The term “communication processing software” refers to a software program or software service that enables transmission and reception of electronic messages, including at least text messages and associated metadata, between users over a communication network.

The term “history data” refers to stored data representing past communication events performed via the communication processing software, including at least message contents, timestamps, sender and recipient identifiers, and conversation identifiers.

The term “user identification information” refers to data that uniquely or pseudo-uniquely identifies a user within a system, such as a user ID, account ID, or other identifier used to associate history data and profile data with that user.

The term “document data” refers to textual content extracted from the history data, including message bodies, subject lines, or other text fields that are subject to natural language processing.

The term “attribute data” refers to non-textual or meta-textual information extracted from the history data, including at least timestamps, participant identifiers, conversation identifiers, message types, and other metadata associated with the document data.

The term “natural language processing algorithm” refers to a software-implemented procedure or model configured to analyze and transform human language text, including operations such as tokenization, part-of-speech tagging, lemmatization, parsing, key phrase extraction, and topic detection.

The term “emotion analysis algorithm” refers to a software-implemented procedure or model configured to identify and quantify emotional characteristics of text or other input signals, including classification of messages into emotional categories and generation of numerical sentiment or emotion scores.

The term “conversation style feature information” refers to data representing statistical or structural characteristics of a user's linguistic behavior, including at least lexical preferences, sentence structure patterns, typical message length, degree of formality, and recurring topic indicators.

The term “emotion state information” refers to quantified data indicating a user's emotional tendency or condition inferred from communication behavior, including at least categorical labels such as positive, negative, or neutral, and numerical scores representing intensity or polarity.

The term “profile data” refers to stored data associated with a user that consolidates conversation style feature information, emotion state information, and optionally other behavioral statistics, and that is used by the system to condition generation, evaluation, and ranking of reply candidates.

The term “terminal device” refers to an end-user computing device, such as a mobile terminal, a portable information processing device, a stationary information processing device, or a wearable display device, that executes user interface functions for presenting reply candidates and transmitting user selections.

The term “new message” refers to a message received or to be responded to in a communication session, which is transmitted from the terminal device to the server for the purpose of generating reply candidates.

The term “context information” refers to structured data describing conditions under which reply candidates are to be generated, including at least writing style conditions, length conditions, emotion conditions, and optionally conversation type, time-of-day information, or counterpart characteristics.

The term “writing style condition” refers to a parameter within the context information that specifies desired linguistic characteristics of generated text, such as formal or informal tone, politeness level, or degree of expressiveness.

The term “length condition” refers to a parameter within the context information that specifies desired constraints on the size of generated text, including at least maximum length, minimum length, or preference for short, medium, or long replies.

The term “emotion condition” refers to a parameter within the context information that specifies target or allowed emotional characteristics of generated text, including requirements for positive, neutral, or supportive tone aligned with the inferred emotion state.

The term “prompt sentence” refers to a structured textual input provided to a generative AI model, which encodes instructions, constraints, user profile information, context information, and a new message, and that conditions the behavior of the generative AI model when it performs text generation.

The term “generative AI model” refers to a machine-implemented model, such as a statistical language model or a neural network-based language generation model, that is configured to generate text outputs based on input data including prompt sentences.

The term “reply candidate text” refers to a generated text string output by the generative AI model in response to a prompt sentence, which is suitable to be used as a candidate reply to the new message in the communication processing software.

The term “reply candidate” refers to a structured unit representing a proposed response to a new message, including at least a reply candidate text and optionally associated evaluation values, sentiment labels, and ranking information.

The term “conversation style compatibility” refers to a measure indicating how closely a reply candidate matches the conversation style feature information of the user, based on comparison of lexical choice, sentence structure, message length, and related features.

The term “emotion consistency” refers to a measure indicating how well emotional characteristics of a reply candidate align with the emotion state information or the emotion condition, including alignment of polarity, intensity, and appropriateness of emotional expressions.

The term “length suitability” refers to a measure indicating whether the length of a reply candidate satisfies the length condition within the context information, including compliance with length limits and user-preferred message size.

The term “evaluation value” refers to a numerical or ordinal score assigned to a reply candidate based on one or more criteria including conversation style compatibility, emotion consistency, and length suitability, and optionally additional factors such as content safety or topic relevance.

The term “presentation order” refers to an arrangement or ranking of multiple reply candidates that determines the sequence in which the reply candidates are presented to the user by the terminal device.

The term “usage history information” refers to data representing user interactions with reply candidates over time, including at least which reply candidate was selected, whether the candidate was edited, and timing information related to such interactions.

The term “content history data” refers to stored data representing user interactions with digital content other than communication messages, including at least viewing history information, playback history information, or access history information for content items.

The term “viewing history information” refers to a subset of content history data indicating which content items, such as audiovisual items or documents, a user has consumed, including identifiers, timestamps, and optionally completion status.

The term “usage history information” in the context of content history refers to data indicating how a user has interacted with content, including content selections, play durations, or engagement signals.

The term “content recommendation information” refers to data describing one or more recommended content items selected or generated for presentation to a user, including identifiers, titles, or descriptions of the recommended items.

The term “content recommendation candidate” refers to a proposed content item included in a generated result, which is suitable to be presented to the user as a recommendation in association with reply candidates.

The term “customer service display device” refers to a display apparatus used in a customer service environment, such as a wearable visual display, a head-mounted display, or another visual output device, that presents response candidates to a service operator in real time.

The term “behavior information” refers to data describing physical or operational behavior of a counterpart party in a real space, including at least actions such as handling an item, approaching a location, or gesturing in a particular manner.

The term “expression information” refers to data describing facial expressions, vocal characteristics, or other observable indicators of emotional state of a counterpart party in a real space, obtained through sensors or recognition algorithms.

The term “additional context information” refers to contextual data acquired from real-world observations, including behavior information and expression information of a counterpart party, which is combined with profile data to condition generation of customer service response candidates.

The term “customer service response candidate” refers to a reply candidate specifically generated for use in a customer service scenario, including phrases or sentences suitable for being spoken or displayed by a service operator to a customer in real time.

In one embodiment, a server, a plurality of terminal devices, and one or more storage devices are interconnected via a communication network. The server includes at least one processor, a main memory, a non-volatile storage device, and a network interface. The terminal includes at least one processor, a display unit, an input unit, a memory, and a communication interface. The user operates the terminal to use communication processing software, such as a messaging client, and to view and select reply candidates provided by the server.

The server executes an operating system, such as a general-purpose server operating system, and application programs implementing communication history collection, natural language processing, emotion analysis, prompt sentence construction, interaction with a generative AI model, and ranking of reply candidates. The server stores history data, profile data, model parameters, and logs in a persistent storage device, such as a relational database management system or a document-oriented database.

The server uses specific software components to process text data. In one example, the server uses a natural language processing library implemented in a high-level programming language to perform tokenization, part-of-speech tagging, lemmatization, and dependency parsing. The server also uses a sentiment or emotion analysis library to compute sentiment polarity and intensity scores for each message, based on a lexicon of positive and negative terms and a trained classifier. The server further accesses a generative AI model hosted on a remote inference service, such as a neural network-based language model accessible via an application programming interface.

The server maintains history data as structured records. The server stores, for each message processed by the communication processing software, at least a message identifier, a user identifier, a counterpart identifier, a timestamp, a conversation identifier, message text, and optional attributes such as message type and channel. The server stores these elements in a normalized schema so that the processor can perform efficient queries and aggregations. The server associates messages with user-level profile data by using the user identifier as a key. The server computes conversation style feature information by processing the document data of the history. The server calculates, for each user, frequency distributions of tokens, bigrams, and higher-order n-grams, distributions of message lengths, counts of informal markers such as emoticons and interjections, and ratios of formal phrases to informal phrases. The server represents these features as numerical vectors, such as fixed-length feature vectors in a multidimensional space. The server uses these vectors as input to a style encoder model, which may be a feedforward neural network or a recurrent neural network that outputs a dense style embedding for each user.

The server computes emotion state information by applying an emotion analysis algorithm to the document data. The server uses a classifier, for example a neural network with an embedding layer, multiple transformer layers, and a final softmax output layer, to map each message to an emotion distribution over classes such as “positive,” “negative,” “neutral,” and “stressed.” The server then aggregates recent emotion outputs using a time-weighted average, where more recent messages have larger weights, to obtain a current emotion vector. The server stores this emotion vector as emotion state information in the profile data.

The server constructs profile data as a composite data structure. The server stores a style embedding, an emotion state vector, and statistics such as typical reply length and responsiveness for each user in a profile record. The server further stores parameters controlling generation conditions, such as default politeness level and typical number of reply candidates. By centralizing these elements in profile data, the server can avoid recomputing low-level statistics for each request and can reduce latency.

The server uses the profile data to generate context information for new messages. When the terminal transmits a new message to the server, the server retrieves the corresponding profile record and combines it with metadata of the new message, such as conversation type and time of day. The server determines writing style conditions by mapping the style embedding to discrete categories (for example “formal,” “casual,” or “very casual”) using a trained classifier. The server determines length conditions by predicting an appropriate target length as a function of the user's typical length and the current conversation type. The server determines emotion conditions by mapping the emotion state vector to target sentiment for replies (for example “mildly positive” or “empathetic neutral”).

The server constructs a prompt sentence by encoding the context information and the new message in a structured natural language instruction. The server arranges the prompt sentence in a deterministic format, for example including a description of the user's style, a description of the desired tone, explicit constraints on length, and the text of the new message. In one example, the server generates the following prompt sentence:
“The user usually writes short, casual messages in Japanese with friendly expressions. The user is currently somewhat tired but positive. Generate 3 short, natural Japanese reply candidates that imitate the user's style and match this emotional state. Message: ‘What should we do for lunch today?’”

In another example, where content recommendation is integrated, the server generates the following prompt sentence:
“Considering that the user loves suspense movies and has written very positive comments recently, generate 2 natural Japanese reply candidates to the message ‘This movie was amazing!’ and recommend 3 similar movies to watch next.”

The server uses these structured prompt sentences to control the behavior of the generative AI model. The server accesses a generative AI model implemented as a large-scale neural network language model with multiple transformer layers, self-attention mechanisms, and learned word embeddings. The server transmits the prompt sentence and hyperparameters, such as maximum token count, sampling temperature, and number of completions, to the inference endpoint. The server thereby causes the generative AI model to perform matrix multiplications, attention score computations, and non-linear activations that generate successive tokens of reply candidate text conditioned not only on the new message but also on the encoded style and emotion information embedded in the prompt sentence.

The server processes the generated output from the generative AI model in a non-conventional manner. The server splits the output into individual reply candidate texts according to delimiters or separate completion segments. The server then re-analyzes each candidate using the same or similar natural language processing algorithms and emotion analysis algorithms used for history analysis. The server quantifies conversation style compatibility by measuring, for example, cosine similarity between the candidate feature vector and the user's style embedding. The server quantifies emotion consistency by computing the difference between the candidate's sentiment vector and the target emotion condition, and by penalizing misaligned polarity or intensity. The server quantifies length suitability by measuring deviation of the candidate's length from the target range specified in the length condition.

The server combines these measures into evaluation values using a weighted scoring function. The server, for example, computes an overall score as a linear combination or a learned function of style compatibility, emotion consistency, length suitability, and optional safety scores derived from a content safety classifier. The server orders the reply candidates in decreasing order of the evaluation value. This ranking is not a simple pass-through of the generative AI model output but an additional technical processing layer that corrects for model variability and ensures stable and user-aligned behavior.

The server transmits the ordered reply candidates to the terminal as structured data including at least text and ranking position. The server reduces communication load by omitting redundant information and by limiting the number of candidates to a configurable maximum determined by historical user selection behavior. This reduction in transmitted data volume contributes to improved network efficiency, especially under high load or on bandwidth-constrained links.

The terminal presents the reply candidates to the user via its display unit. The terminal visually distinguishes higher-ranked candidates, for example by placing them in prominent positions or by using different highlighting. The user can select a candidate by touching the screen, clicking, or performing a gesture, depending on the type of terminal. The terminal may allow the user to edit the text before sending. The terminal then transmits the selected text to the communication processing software, which sends it to the counterpart party using normal messaging mechanisms.

The terminal optionally transmits feedback to the server indicating which candidate was selected, whether it was edited, and the time elapsed between presentation and selection. The server stores this usage history information and periodically updates the profile data and ranking parameters. The server, for example, increases the weights of style compatibility or emotion consistency if candidates with certain characteristics are consistently selected. The server may also adjust sampling parameters for the generative AI model, such as temperature, for users who prefer more varied or more conservative suggestions.

This feedback-driven adaptation improves technical performance over time. Because the server directly modifies evaluation weights and generation parameters based on explicit usage counts and selection statistics, the system converges towards a more efficient configuration with lower average user editing time and reduced rejection rate of candidates. This yields measurable improvements in end-to-end latency, defined as time between receipt of the new message and user confirmation of a reply, and in accuracy, defined as proportion of sessions where a candidate is accepted with minimal editing.

In another embodiment, the server integrates content history data into the same framework. The server stores content viewing history, such as identifiers of audiovisual items, viewing timestamps, and completion flags, in association with the user identifier. The server projects this history into a content preference vector, for example by averaging genre embeddings or latent content embeddings obtained from a recommendation model. The server then extends the profile data to include this content preference vector.

The server, in response to certain types of messages that mention content, combines the content preference vector with the style and emotion data to form extended context information. The server generates a prompt sentence that instructs the generative AI model to output both reply candidates and recommended content titles, as in the example prompt sentence above. The server parses the generated text to separate reply candidate texts and content recommendation candidates and ranks them using criteria such as relevance to the mentioned content, alignment with the emotion state, and historical click-through rates. By performing these additional computations inside the server, the system reduces the need for separate content recommendation services and minimizes redundant network calls, thus improving computation and communication efficiency.

In a further embodiment, the server supports a customer service mode in which a terminal is a wearable display device operated by a clerk. The server acquires additional context information describing behavior and expression of a customer in a real space. The server receives, from sensors coupled to the terminal or from external cameras or microphones, features such as smile probability, gaze direction, and product proximity. The server encodes these features as a context vector and adds it to the profile data of the clerk or to a session profile for the ongoing interaction.

The server constructs a prompt sentence that includes a description of the customer's behavior and expression, as well as the clerk's style and emotion state. An example prompt sentence in this mode is:
“The customer is smiling and holding a product in a physical store. The clerk usually speaks in polite but friendly Japanese. Generate 3 polite and positive Japanese customer service phrases suitable for this situation.”

The server transmits this prompt sentence to the generative AI model, receives multiple customer service response candidates, and evaluates them using similar criteria as for chat replies, with additional constraints such as compliance with store policies and avoidance of prohibited terms. The server ranks the candidates and sends them to the wearable display device. The terminal displays the phrases in real time near the clerk's field of view, enabling rapid selection and verbalization. This configuration couples the generative and ranking algorithms to a specific hardware control loop: the server's ranking directly determines which text is rendered on the wearable display within tight latency constraints, thereby improving responsiveness and consistency of customer service beyond what manual processes can achieve.

The server, in all of these embodiments, implements the generative AI model interface and evaluation algorithms as modular components. The server can use alternative neural network architectures, such as encoder-decoder models or recurrent neural networks, in place of transformer-only models. The server can modify the loss function used during off-line fine-tuning of the generative AI model to emphasize fidelity to style embeddings and emotion state vectors, for example by adding auxiliary loss terms that penalize deviations of generated sentiment from target sentiment. The server can employ data augmentation techniques when training emotion classifiers, such as synonym replacement or back-translation, to improve robustness to noisy user messages.

The server thereby uses the generative AI model not as a generic text generator but as a controlled component in a larger technical pipeline that encodes, transforms, and ranks text under explicit, machine-interpretable constraints. This arrangement differs from human work automation because the server performs complex numerical operations on high-dimensional embeddings, directly optimizes for computational metrics such as latency and bandwidth, and systematically adjusts algorithmic parameters based on accumulated interaction statistics. The specific combination of profile data structures, context-rich prompt sentences, multi-criteria evaluation, and feedback-driven adaptation produces technical effects including improved reply accuracy, reduced user editing, reduced network overhead, and more efficient utilization of generative model compute resources.

In alternative embodiments, the server may execute some or all of the analysis and ranking logic on edge servers or on the terminal itself, storing profile data locally or in a distributed cache to reduce round-trip times. The server may compress profile vectors and history features using dimensionality reduction methods, such as principal component analysis or autoencoders, to reduce memory footprint and speed up similarity computations. The server may also integrate hardware accelerators, such as graphics processing units or tensor processing units, to parallelize natural language processing and emotion analysis operations, thereby further reducing processing time and enabling real-time operation for a larger number of users.

The terminal may take various forms, including smartphones, tablet computers, desktop computers, head-mounted displays, and in-vehicle devices. The user may be an individual consumer, a business operator, a customer service agent, or any other person interacting with communication processing software. In each case, the server, the terminal, and the network cooperate to implement the described system, and variations in hardware and software configuration may be made without departing from the scope of the claims.

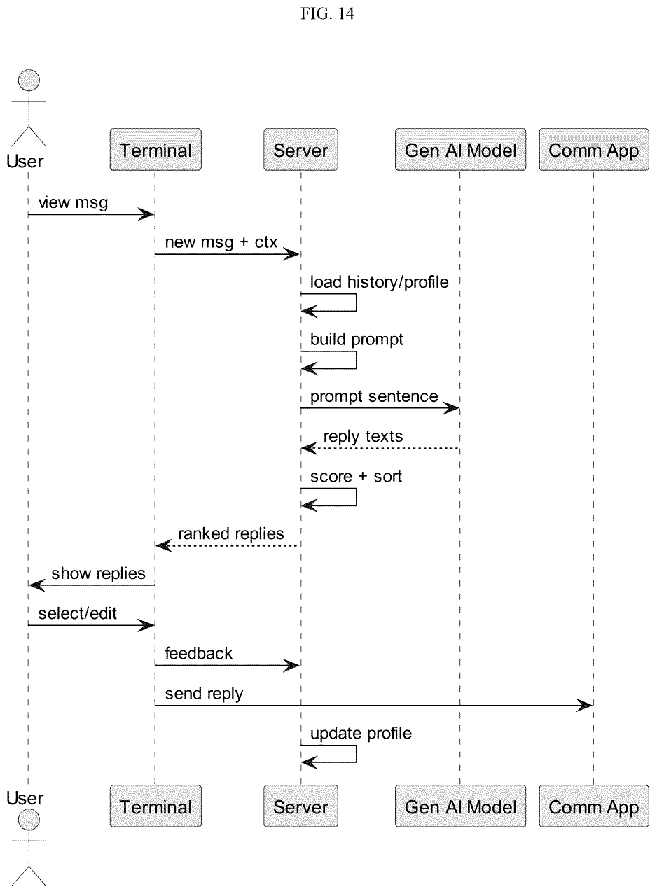

The following describes the processing flow using FIG. 14.

### Step 1:

The server acquires history data from the communication processing software.

The server receives, as input, user identification information and a request to update history. Based on this input, the server calls an application programming interface of the communication processing software and obtains raw message records including message text, timestamps, sender and recipient identifiers, and conversation identifiers. The server performs data parsing on the raw response, normalizes character encoding, removes unsupported control characters, and separates document data (message text) from attribute data (metadata). The server outputs structured history records and stores them in a storage device indexed by user identification information.

### Step 2:

The server computes conversation style feature information from the history data.

The server receives, as input, the document data and attribute data of messages associated with a particular user. The server applies natural language processing algorithms to the document data, including tokenization, part-of-speech tagging, and phrase extraction, and calculates statistics such as word frequency distributions, average sentence length, use of informal markers, and topic keywords. The server then aggregates these statistics into numerical feature vectors that represent conversation style. The server outputs conversation style feature information and stores it as part of profile data for the user.

### Step 3:

The server computes emotion state information from the history data.

The server receives, as input, the same document data used for style analysis and, optionally, a subset of most recent messages. The server applies an emotion analysis algorithm, such as a neural network classifier, to each message to detect emotional expressions and to compute sentiment scores along dimensions such as positivity, negativity, and stress. The server performs data aggregation over a sliding time window by applying weighted averaging or other statistical operations to the sentiment scores, and generates a current emotion state vector. The server outputs emotion state information and records it in the profile data for the user.

### Step 4:

The server constructs profile data for the user.

The server receives, as input, the conversation style feature information and the emotion state information computed for the user. The server combines these inputs into a unified data structure that includes a style embedding, an emotion state vector, and derived attributes such as preferred reply length and typical degree of formality. The server may compress or normalize the feature values and assign a profile identifier. The server outputs updated profile data and stores it in a profile database keyed by user identification information.

### Step 5:

The terminal transmits a new message and context to the server.

The terminal receives, as input from the user or from a counterpart party, a new message that appears in the communication processing software interface. The terminal extracts the new message text, conversation identifier, counterpart identifier, and timestamp from the communication processing software. The terminal optionally attaches context information such as conversation type and recent message snippets. The terminal outputs a generation request containing the new message and the context, and sends this request via a network interface to the server.

### Step 6:

The server determines generation conditions and builds context information.

The server receives, as input, the generation request from the terminal, including the new message and basic context. The server retrieves the corresponding profile data for the user from the profile database. The server applies classification and regression algorithms to the style embedding and emotion state vector to determine writing style conditions (such as formal or casual), length conditions (such as short or medium), and emotion conditions (such as positive or empathetic). The server assembles these parameters into structured context information. The server outputs the context information as a set of generation conditions for reply candidates.

### Step 7:

The server generates a prompt sentence for a generative AI model.

The server receives, as input, the context information and the new message text. The server performs string concatenation and template filling to construct a structured natural language instruction that encodes the writing style condition, length condition, emotion condition, and the exact text of the new message. For example, the server generates a prompt sentence such as:
“The user usually writes short, casual messages in Japanese with friendly expressions. The user is currently somewhat tired but positive. Generate 3 short, natural Japanese reply candidates that imitate the user's style and match this emotional state. Message: ‘What should we do for lunch today?’”

The server outputs the constructed prompt sentence as a textual input ready for the generative AI model.

### Step 8:

The server requests text generation from the generative AI model.

The server receives, as input, the prompt sentence and a set of generation parameters, such as maximum token count, sampling temperature, and number of completions. The server sends this data to a generative AI model service via a model interface over a communication network. Internally, the generative AI model executes neural network computations, including embedding lookup, multiple transformer layers, attention calculations, and probability sampling, to produce one or more text outputs conditioned on the prompt sentence. The server receives, as output, a set of generated text segments representing reply candidate texts.

### Step 9:

The server parses and normalizes reply candidate texts.

The server receives, as input, the raw output from the generative AI model, which may be formatted as multiple completions or a single text block with delimiters. The server applies text parsing operations to split the raw output into individual reply candidate texts and trims whitespace, removes artifacts such as repeated headers, and normalizes character encoding and emoji representations. The server optionally validates that each candidate is in the desired language and satisfies basic length constraints. The server outputs a list of cleaned reply candidate texts for further evaluation.

### Step 10:

The server evaluates and scores the reply candidates.

The server receives, as input, the list of reply candidate texts and the profile data of the user, including conversation style feature information and emotion state information. The server applies natural language processing algorithms to each candidate to compute feature vectors analogous to the user's style features. The server applies an emotion analysis algorithm to each candidate to obtain sentiment or emotion vectors. The server then performs numerical operations, such as cosine similarity, difference computation, and penalty functions, to measure conversation style compatibility, emotion consistency, and length suitability for each candidate. The server combines these measures using a scoring function to calculate an evaluation value for each reply candidate. The server outputs a list of candidates associated with their evaluation values.

### Step 11:

The server determines a presentation order for the reply candidates.

The server receives, as input, the list of reply candidates and corresponding evaluation values. The server applies a sorting algorithm, such as descending order by evaluation value, and may apply tie-breaking rules based on length or diversity. The server optionally filters out candidates whose evaluation values fall below a threshold. The server outputs an ordered list of reply candidates, where each candidate includes its text and ranking position according to the determined presentation order.

### Step 12:

The server transmits ordered reply candidates to the terminal.

The server receives, as input, the ordered list of reply candidates and identifiers necessary to route the response, such as a session identifier or conversation identifier. The server formats the ordered replies in a response structure and sends this data through the network interface to the terminal. The server may compress the payload or limit the number of candidates to reduce communication load. The server outputs a network response that delivers the ordered reply candidates to the terminal for display.

### Step 13:

The terminal displays the reply candidates to the user.

The terminal receives, as input, the ordered list of reply candidates from the server. The terminal updates its user interface by generating visual elements such as selectable buttons or message bubbles for each candidate, placing them in the order provided by the server. The terminal may highlight the highest-ranked candidate or display additional indicators, such as icons or labels, to show recommended options. The terminal outputs updated screen content to the display unit, presenting the reply candidates for user selection.

### Step 14:

The user selects and optionally edits a reply candidate.

The user receives, as input via the display, the list of reply candidates shown by the terminal. The user performs a selection operation, such as tapping or clicking on a candidate, to indicate a chosen reply. If an edit function is available, the user may modify the text using the input unit, for example by adding phrases or changing wording. The user then confirms the sending action. The user's actions result in an edited or unedited text string and a confirmation event that are provided to the terminal as output of user interaction.

### Step 15:

The terminal sends the selected reply through the communication processing software.

The terminal receives, as input, the selected and possibly edited text from the user and the associated conversation identifier. The terminal writes this text into the input field of the communication processing software or calls an application programming interface of the communication processing software to send the message directly. The terminal triggers the send action so that the communication processing software transmits the message to the counterpart party over the communication network. The terminal outputs a confirmation to the user by updating the conversation view to include the sent message.

### Step 16:

The terminal reports usage history information to the server.

The terminal receives, as input, the identity or index of the reply candidate that was originally selected, an indicator of whether the user edited the text, and timing information such as the interval between display and selection. The terminal packages this information together with user identification information and session identifiers. The terminal sends this data to the server as a feedback report. The terminal outputs the feedback report without affecting the already-sent communication message.

### Step 17:

The server updates profile data and evaluation parameters based on feedback.

The server receives, as input, the feedback report from the terminal, including selected candidate identification, edit presence, and interaction timing. The server looks up the corresponding generation session and profile data. The server increments counters or updates aggregates for events such as “candidate accepted without editing,” “candidate accepted with editing,” or “candidate rejected.” The server adjusts weights in the scoring function or updates thresholds for style compatibility, emotion consistency, and length suitability based on accumulated statistics, using algorithms such as incremental averaging or gradient-based updates. The server outputs updated profile data and updated evaluation parameters, which are stored for use in future candidate generation and ranking.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

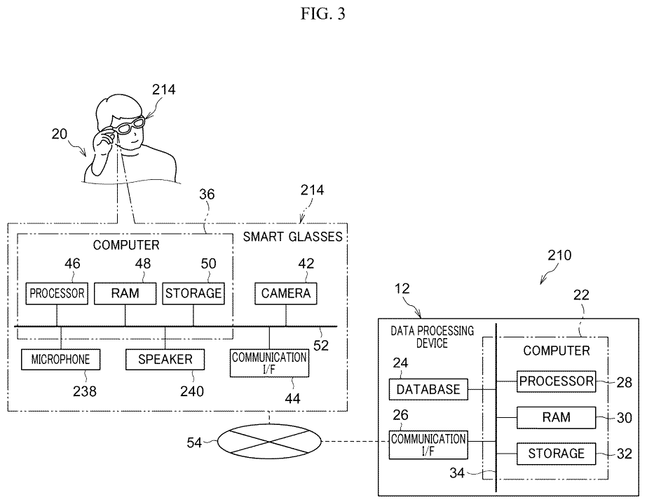

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

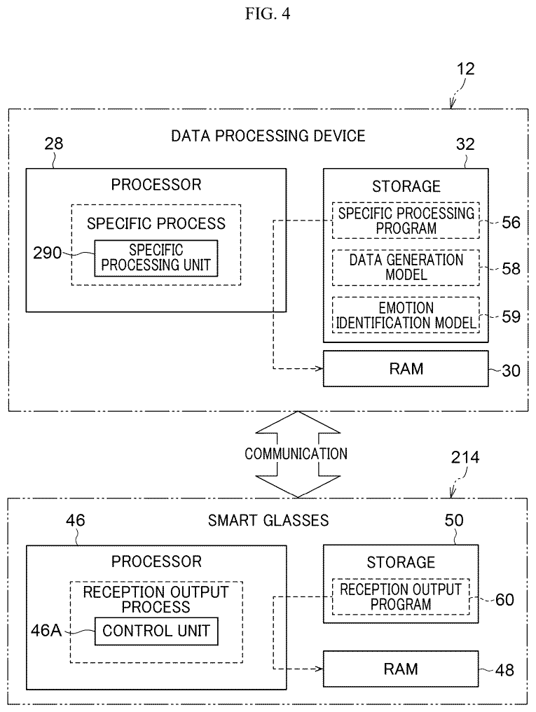

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

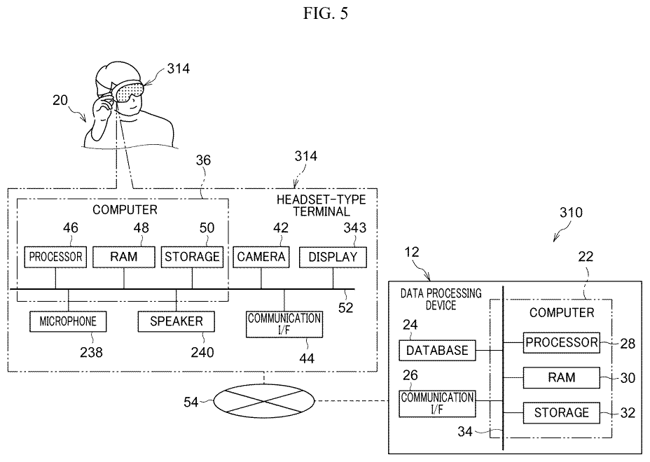

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

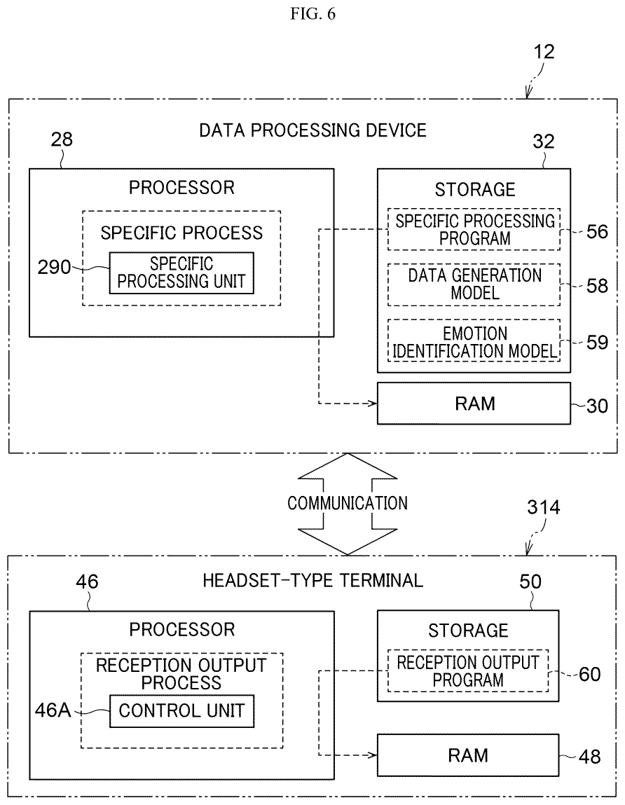

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

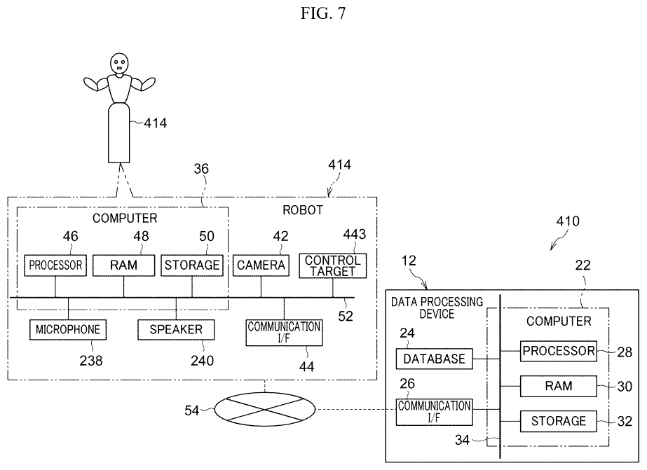

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

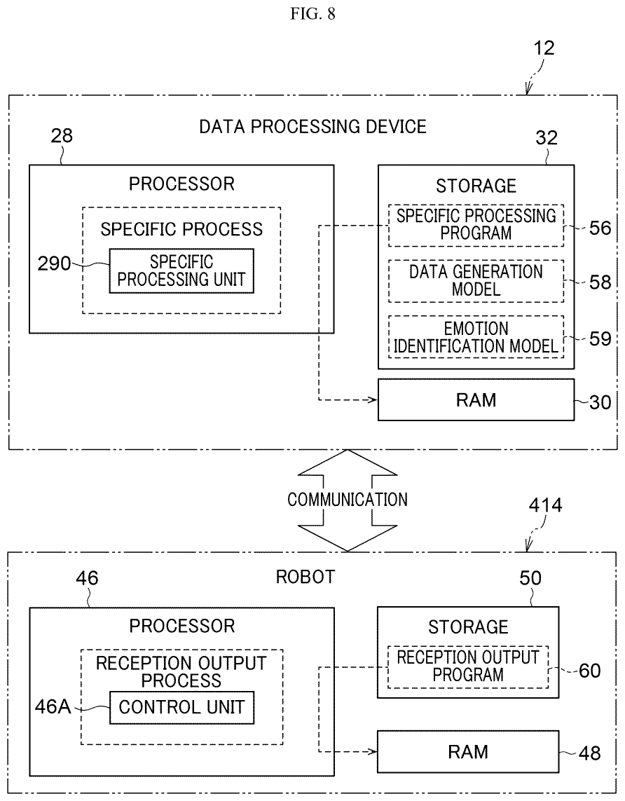

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

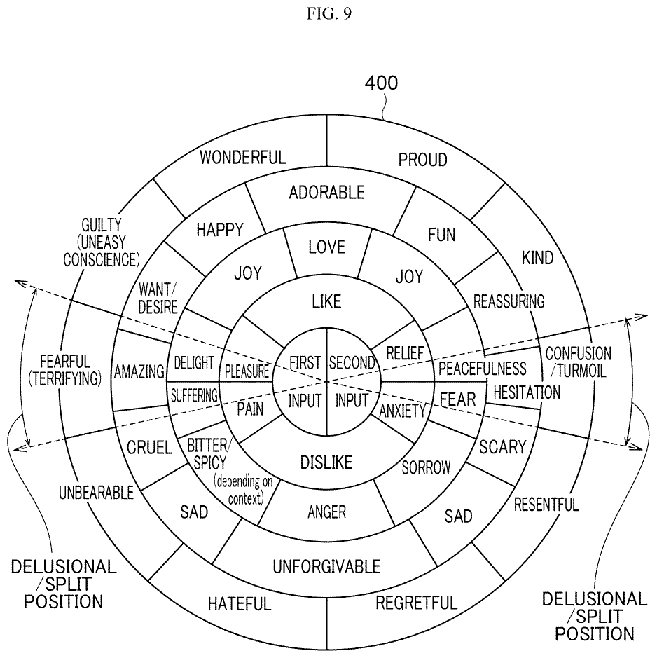

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

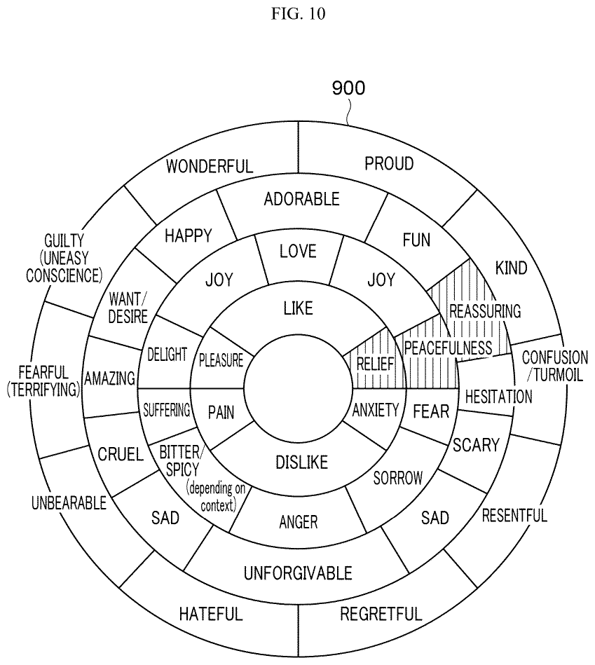

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a communication application associated with a user, conversation history data via authentication information, and extract message content and time information from the conversation history data; and
perform preprocessing on the message content included in the conversation history data, the preprocessing including character type conversion, removal of unnecessary symbols, word segmentation, and removal of function words, so as to generate standardized text data suitable for analysis; and
generate feature data including word frequency information, phrase sequence frequency information, topic distribution information, and writing style information, by applying statistical natural language processing and machine learning to the standardized text data; and construct a learning model using an unsupervised learning algorithm based on the feature data, and generate a user style representation representing a language usage tendency and a conversation topic tendency of the user; and
generate a style-aware prompt sentence to be input to a generative AI model, based on the user style representation and a prompt sentence received from the user, and instruct the generative AI model to input the style-aware prompt sentence; and
select, from among response candidates output from the generative AI model, a response candidate consistent with the user style representation, present the selected response candidate to the user, and transmit a response candidate selected by the user via the communication application.

### Supplementary 2

The system according to supplementary 1,
wherein the processor is configured to
cause the generative AI model to receive, as conditioning information, an embedding vector or topic information corresponding to the user style representation, and automatically generate the response candidates by combining the conditioning information with the style-aware prompt sentence.

### Supplementary 3

The system according to supplementary 1,
wherein the processor is configured to
execute an emotion expression extraction process on the standardized text data to generate emotion feature data, integrate the emotion feature data with the feature data to construct the user style representation, and specify an emotional tendency of the response candidates within the style-aware prompt sentence based on the user style representation.

### Application Example 1

### Supplementary 1

A system comprising a processor,
wherein the processor is configured to
acquire history information from a communication information processing program executed on a user communication information processing device, and
extract character information from the history information, preprocess the character information by using a language processing information processing program, and extract a sequence of lexical units and frequent lexical units, and
generate numerical feature quantities for the extracted lexical units by using a trained information processing model, and classify an interest field of the user on the basis of the numerical feature quantities, and
generate a prompt sentence, for instructing a generative information processing model to generate or select related information, on the basis of the classified interest field and the lexical units extracted from the history information, and
input the prompt sentence to the generative information processing model and cause the generative information processing model to generate a set of information items related to the interest field, and
acquire additional information from an external information providing device on the basis of the generated set of information items, and complement the information items to construct recommendation information, and
transmit the recommendation information to a user communication terminal device, and convert the recommendation information into a displayable format in the user communication terminal device, and
acquire a selection operation or a viewing action, with respect to the recommendation information, by the user, and store the acquired action as the history information and reuse the history information for the classification and generation processing.

### Supplementary 2

The system according to supplementary 1,
wherein the processor is configured to
generate the prompt sentence to be input to the generative information processing model as a structured instruction sentence including a type of the interest field, a number of required information items, an output format, and lexical units to be used as search terms.

### Supplementary 3

The system according to supplementary 1,
wherein the processor is configured to
assign a weight to the recommendation information associated with the classified interest field on the basis of a confidence level of a classification result and a past selection history of the user, and control at least one of a presentation order and a presentation presence of the recommendation information.

### Example 2

### Supplementary 1

A system comprising a processor,
wherein the processor is configured to
acquire transmission and reception records of a user from a communication software executed on a terminal device, structure the transmission and reception records on a conversation unit or response-pair basis, and store the structured transmission and reception records in a storage region,
remove symbol information, decoration information, and unnecessary information from the transmission and reception records, normalize variations in character representation in textual information, and format the transmission and reception records as a training data set including a correspondence relationship between utterances of the user and utterances of a communication partner,
input training instruction information to a generative artificial intelligence model based on the training data set in order to cause the generative artificial intelligence model to learn a conversation style and a response tendency of the user, cause the generative artificial intelligence model to generate style information or parameter information reflecting a user-specific conversation style, and store the style information or the parameter information in association with user identification information,
acquire a newly received message and conversation history information based on the transmission and reception records, and generate a prompt sentence for causing the generative artificial intelligence model to generate one or more reply candidates, based on the style information or the parameter information,
input the prompt sentence to the generative artificial intelligence model, obtain, from the generative artificial intelligence model, a plurality of reply candidates that imitate the conversation style of the user, and perform post-processing on the reply candidates including at least a length constraint and expression safety checking, and
transmit the post-processed plurality of reply candidates to the terminal device, and output information for causing the terminal device to allow the user to select at least one of the plurality of reply candidates, to accept an editing operation for a selected reply candidate, and to transmit an edited reply message via the communication software.

### Supplementary 2

The system according to supplementary 1,
wherein the processor is configured to apply natural language processing to conversation history obtained from the transmission and reception records, detect emotional expressions including positive expressions and negative expressions, quantify an emotional tendency based on the emotional expressions, and dynamically change style designation information or output constraint information in the prompt sentence based on the emotional tendency.

### Supplementary 3

The system according to supplementary 1,
wherein the processor is configured to receive an instruction prompt sentence input by the user via the terminal device, generate an input prompt sentence for the generative artificial intelligence model by combining the instruction prompt sentence with the style information or the parameter information, and cause the generative artificial intelligence model to generate one or more reply candidates corresponding to a specific situation based on the input prompt sentence.

### Application Example 2

### Supplementary 1

A system comprising a processor,
wherein the processor is configured to
acquire, based on user identification information, history data from a communication processing software, extract document data and attribute data from the history data, and store the document data and the attribute data,
analyze the document data by using a natural language processing algorithm to perform preprocessing and to calculate conversation style feature information including lexical information, sentence structure information, and topic information, analyze the document data by using an emotion analysis algorithm to detect emotional expressions and to generate quantified emotion state information, and record, as profile data for each user, the conversation style feature information and the emotion state information,
receive, from a terminal device, a new message, and determine context information including a writing style condition, a length condition, and an emotion condition as reply candidate generation conditions based on the new message and the profile data, and generate a prompt sentence including the context information and the new message,
input the prompt sentence as input data to a generative AI model, request a text generation process to the generative AI model, and obtain a plurality of reply candidate texts from the generative AI model, thereby generating a plurality of reply candidates that imitate a reply of the user,
evaluate contents of the plurality of reply candidates by using the natural language processing algorithm and the emotion analysis algorithm, calculate evaluation values based on a conversation style compatibility degree, an emotion consistency degree, and a length suitability degree, and determine a presentation order of the plurality of reply candidates according to the evaluation values,
transmit, according to the presentation order, the plurality of reply candidates to the terminal device so that the plurality of reply candidates are visually presented to the user by the terminal device, and cause text data corresponding to a reply candidate selected by the user to be transmitted, as a message, by the communication processing software, and
acquire usage history information including a selection result of the reply candidate by the user and presence or absence of editing, and update the profile data and an evaluation condition for determining the presentation order based on the usage history information.

### Supplementary 2

The system according to supplementary 1,
wherein the processor is configured to
acquire content history data including viewing history information or usage history information based on the history data of the communication processing software and the emotion state information, generate a prompt sentence for simultaneously generating a reply candidate text and content recommendation information by using the content history data and the profile data, input the prompt sentence to the generative AI model, obtain a generation result including a reply candidate and a content recommendation candidate, and cause the reply candidate and the content recommendation candidate to be presented by the terminal device.

### Supplementary 3

The system according to supplementary 1,
wherein the processor is configured to
control an operation mode in which response candidates are presented via a customer service display device based on the profile data and the emotion state information, input to the generative AI model a prompt sentence including additional context information acquired based on behavior information or expression information of a counterpart party in a real space, generate customer service response candidates corresponding to the additional context information, and cause the customer service response candidates to be presented in real time on the customer service display device.

What is claimed is:

1. A system comprising:
circuitry configured to:
receive, via a communication interface coupled to a packet-switched network, conversation history data from a terminal device, the conversation history data including message content from a communication application associated with a user, and store the conversation history data in a storage device;
analyze the conversation history data using a natural language processing technique to determine a conversation style and an emotional state of the user, and generate a prompt sentence for a generative AI model based on the conversation style and the emotional state; and
input the prompt sentence to the generative AI model to generate reply candidates that reflect the conversation style and the emotional state of the user, and transmit the reply candidates to the terminal device via the communication interface.

2. The system according to claim 1, wherein the circuitry is configured to perform preprocessing on message content in the conversation history data including character type conversion, removal of unnecessary symbols, word segmentation, and removal of function words, and generate standardized text data suitable for analysis.

3. The system according to claim 2, wherein the circuitry is configured to generate feature data including word frequency information, phrase sequence frequency information, topic distribution information, and writing style information by applying statistical natural language processing and machine learning to the standardized text data.

4. The system according to claim 3, wherein the circuitry is configured to construct a learning model using an unsupervised learning algorithm based on the feature data, and generate a user style representation representing a language usage tendency and a conversation topic tendency of the user.

5. The system according to claim 4, wherein the circuitry is configured to generate a style-aware prompt sentence based on the user style representation and a prompt sentence received from the terminal device via the communication interface, and cause the generative AI model to receive an embedding vector or topic information corresponding to the user style representation as conditioning information.

6. The system according to claim 5, wherein the circuitry is configured to select, from among reply candidates output from the generative AI model, a reply candidate consistent with the user style representation, and transmit a reply candidate selected by the user to a destination via the communication interface.

7. The system according to claim 1, wherein the circuitry is configured to detect positive or negative expressions from the conversation history data using the natural language processing technique, and quantify an emotional tendency of the user based on detected expressions.

8. The system according to claim 7, wherein the circuitry is configured to reflect the quantified emotional tendency in the prompt sentence generated for the generative AI model to control a tone of the generated reply candidates.

9. The system according to claim 8, wherein the circuitry is configured to generate emotion feature information from the conversation history data in addition to the writing style information, and incorporate the emotion feature information into the prompt sentence.

10. The system according to claim 1, wherein the circuitry is configured to generate the prompt sentence by combining the user style representation with a message received from the terminal device that is a target for reply, so that the generative AI model generates reply candidates that are contextually appropriate for the target message.

11. The system according to claim 10, wherein the circuitry is configured to generate a plurality of reply candidates for a single target message, rank the reply candidates based on consistency with the user style representation, and present a ranked list of reply candidates to the terminal device.

12. The system according to claim 1, wherein the circuitry is configured to receive, from the terminal device via the communication interface, a selection of one of the reply candidates made by the user, and transmit the selected reply candidate via the communication application.

13. The system according to claim 12, wherein the circuitry is configured to update the conversation history data stored in the storage device with the selected reply candidate and new incoming messages, and regenerate the user style representation based on the updated conversation history data.

14. The system according to claim 1, wherein the circuitry is configured to acquire the conversation history data from the communication application using authentication information received from the terminal device via the communication interface.

15. The system according to claim 1, wherein the circuitry is configured to generate a style-aware prompt sentence that includes at least a vocabulary sample, a tone descriptor, and a topic context derived from the user style representation.

16. The system according to claim 1, wherein the circuitry is configured to detect a change in the emotional state of the user between a first time period and a second time period based on the conversation history data, and adjust the prompt sentence to reflect the detected change.

17. The system according to claim 16, wherein the circuitry is configured to store a time-stamped record of emotional state changes for the user in the storage device, and use the stored record to generate prompt sentences that account for temporal patterns in the user's emotional state.

18. A system comprising:
circuitry configured to:
receive, via a communication interface coupled to a packet-switched network, conversation history data from a terminal device and store the conversation history data in a storage device;
preprocess the conversation history data to generate standardized text data, generate feature data from the standardized text data using a natural language processing technique, construct a user style representation based on the feature data, and generate a style-aware prompt sentence incorporating the user style representation;
input the style-aware prompt sentence to a generative AI model and select, from reply candidates generated by the generative AI model, a reply candidate consistent with the user style representation; and
transmit the selected reply candidate to the terminal device via the communication interface.

19. The system according to claim 18, wherein the circuitry is configured to detect positive or negative expressions from the conversation history data and quantify an emotional tendency of the user, and incorporate the quantified emotional tendency into the style-aware prompt sentence to control a tone of the reply candidates generated by the generative AI model.

20. A method comprising:
receiving, via a communication interface coupled to a packet-switched network, conversation history data from a terminal device, the conversation history data including message content from a communication application associated with a user, and storing the conversation history data in a storage device;
analyzing the conversation history data using a natural language processing technique to determine a conversation style and an emotional state of the user, and generating a prompt sentence for a generative AI model based on the conversation style and the emotional state; and
inputting the prompt sentence to the generative AI model to generate reply candidates that reflect the conversation style and the emotional state of the user, and transmitting the reply candidates to the terminal device via the communication interface.
